(19) United States
(12) Patent Application Publication
(10) Pub. No.: US 2015/0269524 A1
(43) Pub. Date: Sep. 24, 2015

(54) DEVICE, METHOD, AND COMPUTER-READABLE MEDIUM FOR PROJECT MANAGEMENT

(71) Applicant: Transformative Software, Inc., Montgomery Village, MD (US)

(72) Inventors: David J. Greene, Montgomery Village, MD (US); Scottie M. Lee, Alexandria, VA (US)

(21) Appl. No.: 14/666,011

(22) Filed: Mar. 23, 2015

Related U.S. Application Data
(60) Provisional application No. 61/967,575, filed on Mar. 21, 2014.

(51) Int. Cl. G06Q 10/10; G06F 3/0484; G06F 3/0482; G06F 3/0488

(52) U.S. Cl. CPC G06Q 10/103; G06F 3/0488; G06F 3/04847; G06F 3/0482; G06F 3/04842

(57) ABSTRACT

Embodiments include methods for interactive selection and display of project management information comprising: displaying first graphical information relating to a plurality of resources and to a project duration; receiving a signal indicating user modification of at least a portion of the displayed graphical information; calculating a revised allocation over the project duration for at least one of the plurality of resources; and displaying second graphical information based on the calculated revised allocation of resources. The signal may be generated in response to user movement or actuation of slider, graphic equalizer, and/or multi-segment bar controls. The signal may indicate modification of start/end date(s), total hours, or resource allocation over time. Second graphical information may include resource allocation as percentage of project requirement, utilization of at least one resource during a project, and/or monetary forecast. Embodiments also include user interface devices and computer-readable media embodying one or more of these methods.

### CROSS-REFERENCE TO RELATED APPLICATIONS

This application claims the priority of U.S. Provisional Application Ser. No. 61/967,575, entitled “System and Method for Project Management,” which was filed Mar. 21, 2014 and is incorporated herein by reference.

### FIELD OF TECHNOLOGY

The disclosure herein relates to the field of computer-based project management technology, more specifically to graphical-based project management applications and user interface devices which can utilize such graphical applications.

### BACKGROUND

In general, current project management systems struggle with three main challenges. First, they require vast amounts of manual user input to set up a project, then frequent and laborious manual input as the project progresses. This repulses users, who rarely use the system's full feature set. This also dilutes the system's intended value. Second, they do not convey information in an intuitive format. Pertinent information for different types of users is displayed in only one unified and inelegant way, reducing its usefulness to a diverse audience; they are designed strictly for hard-core project managers. Therefore the system may only be useful to a small group within a company.

Third, and arguably most importantly, they compartmentalize information via the lack of a unified, fluidly dynamic feature set. In other words, what happens in one feature set does not elegantly translate into other feature sets. For example, the setting up of a project does not instantly translate into a budget. And the creation of a budget does not instantly translate into a set of resource needs. And the setting up of resource needs does not instantly translate into a budget. And the setting up of resource needs does not elegantly translate into a financial forecast across time that is tied to the ebb and flow of certain resources in relation to their bill rate. Nor does ebb and flow get fluidly, and instantly, measured against the capacity of a discipline, title or named resource.

### SUMMARY

Embodiments of the present disclosure address such challenges by uniquely managing significant amounts of numerical data using novel user interface techniques such as sliding the timeframe viewed and/or sliding, condensing or stretching a project across time. Client financial forecast and overall company forecast can be adjusted in real-time in response to sliding, condensing or stretching of projects via the novel user interface techniques.

Embodiments of the present disclosure may utilize pre-set budgets for each type of project, from which they can derive data used for creating and managing individual projects. Such pre-set budgets may be uniquely created and customizable via user interface (e.g., slider) functionality. Moreover, embodiments may include additional novel user interface features (e.g., graphic equalizer) that can be employed to allocate or distribute resource requirements across discrete portions of the duration of a project.

Embodiments of the present disclosure may graphically display resource forecasts (e.g., utilization vs. capacity) for selectable periods of a project in an easily understandable, color-coded manner. Colors may be assigned based on the resource needs on that day, for each discipline, across all company projects. Such graphical resource forecasts can be adjusted in real-time in response to the novel user interface techniques. Such real-time updates may provide project managers with very timely views of present and future resources needs under various actual and hypothetical conditions.

Exemplary embodiments of the present disclosure include a user interface device (e.g., a tablet computer) comprising a touch-sensitive display and a processor configured with application program code that provides capabilities for interactive selection and display of project management information. When executed by the processor, the application program causes the device to display first graphical information relating to a plurality of resources and to a project duration; receive a first signal indicating user modification of at least a portion of the displayed graphical information; calculate a revised allocation over the project duration for at least one of the plurality of resources; and display second graphical information based on the calculated revised allocation of resources.

In some exemplary embodiments, the first graphical information can comprise: the total number of hours allocated over the project duration for each of the resources; portions of the total number of hours for one or more resources that are allocated in a plurality of portions of the project duration; and/or a multi-segment bar indicating resource allocation over at least a portion of the project duration. In some exemplary embodiments, the first signal can indicate user modification of at least one of the portions of the total number of hours that are allocated in the plurality of portions of the project duration; user modification of the total number of hours allocated over the project duration for at least a portion of the resources; and/or user modification of at least one of the project start date and the project end date.

In some embodiments, the device comprises a touchscreen display and the first signal can be generated in response to: actuation of a graphic equalizer control rendered on the touch screen display; actuation of a slider control rendered on the touch screen display; a change in the position and/or the length of the multi-segment bar. In some embodiments, the second graphical information can comprise: utilization percentage of at least one resource during at least one day of the project duration; resource allocation as a percentage of project requirement during at least one day of the project duration; and/or a monetary forecast.

Exemplary embodiments also include methods and non-transitory, computer-readable media comprising the procedures performed by the application executing on the user interface device.

These and other objects, features and advantages of the exemplary embodiments of the present disclosure will become apparent upon reading the following detailed description of the exemplary embodiments of the present disclosure, when taken in conjunction with the appended claims.

### DESCRIPTION OF THE DRAWINGS

The detailed description will refer to the following drawings, wherein like numerals refer to like elements, and wherein:

FIG. 1 is an exemplary time interface screen display rendered by an application program executing on a user interface device, according to embodiments of the present disclosure;

FIG. 2 is another exemplary time interface screen display, according to embodiments of the present disclosure;

FIG. 3a is another exemplary time interface screen display, according to embodiments of the present disclosure;

FIG. 3b is another exemplary time interface screen display, according to embodiments of the present disclosure;

FIG. 4 is another exemplary time interface screen display, according to embodiments of the present disclosure;

FIG. 5 is another exemplary time interface screen display, according to embodiments of the present disclosure;

FIG. 6 is an exemplary money interface screen display rendered by an application program executing on a user interface device, according to embodiments of the present disclosure;

FIG. 7 is another exemplary money interface screen display, according to embodiments of the present disclosure;

FIG. 8 is an exemplary resources interface screen display rendered by an application program executing on a user interface device, according to embodiments of the present disclosure;

FIG. 9a is another exemplary resources interface screen display, according to one or more embodiments of the present disclosure;

FIG. 9b is another exemplary resources interface screen display, according to one or more embodiments of the present disclosure;

FIG. 10 is an exemplary administrative screen display for adding a new discipline, according to one or more embodiments of the present disclosure;

FIG. 11 is an exemplary administrative screen display for viewing existing disciplines, according to one or more embodiments of the present disclosure;

FIG. 12 is an exemplary administrative screen display for revising an existing discipline, according to one or more embodiments of the present disclosure;

FIG. 13 is an exemplary administrative screen display for adding a new title, according to one or more embodiments of the present disclosure;

FIG. 14 is an exemplary administrative screen display for viewing existing titles, according to one or more embodiments of the present disclosure;

FIG. 15 is an exemplary administrative screen display for revising an existing title, according to one or more embodiments of the present disclosure;

FIG. 16 is an exemplary administrative screen display for adding a new client, according to one or more embodiments of the present disclosure;

FIG. 17 is another exemplary administrative screen display for adding a new client, according to one or more embodiments of the present disclosure;

FIG. 18 is an exemplary administrative screen display for viewing existing clients, according to one or more embodiments of the present disclosure;

FIG. 19 is another exemplary administrative screen display for viewing existing clients, according to one or more embodiments of the present disclosure;

FIG. 20 is an exemplary administrative screen display for revising an existing client, according to one or more embodiments of the present disclosure;

FIG. 21 is another exemplary administrative screen display for revising an existing client, according to one or more embodiments of the present disclosure;

FIG. 22 is an exemplary administrative screen display for adding a new user, according to one or more embodiments of the present disclosure;

FIG. 23 is another exemplary administrative screen display for adding a new user, according to one or more embodiments of the present disclosure;

FIG. 24 is an exemplary administrative screen display for viewing existing users, according to one or more embodiments of the present disclosure;

FIG. 25 is another exemplary administrative screen display for revising an existing user, according to one or more embodiments of the present disclosure;

FIG. 26 is an exemplary administrative screen display for adding a new project type, according to one or more embodiments of the present disclosure;

FIG. 27 is an exemplary administrative screen display for viewing existing project types, according to one or more embodiments of the present disclosure;

FIG. 28 is an exemplary administrative screen display for revising an existing project type, according to one or more embodiments of the present disclosure;

FIG. 29 is an exemplary administrative screen display for adding a new project prefix, according to one or more embodiments of the present disclosure;

FIG. 30 is an exemplary administrative screen display for viewing existing project prefix, according to one or more embodiments of the present disclosure;

FIG. 31 is an exemplary administrative screen display for revising an existing project prefix, according to one or more embodiments of the present disclosure;

FIG. 32 is an exemplary administrative screen display for adding a new project code, according to one or more embodiments of the present disclosure;

FIG. 33 is an exemplary administrative screen display for viewing existing project codes, according to one or more embodiments of the present disclosure;

FIG. 34 is an exemplary administrative screen display for revising an existing project code, according to one or more embodiments of the present disclosure;

FIG. 35 is an exemplary administrative screen display for viewing and modifying working time information, according to one or more embodiments of the present disclosure;

FIG. 36 is an exemplary computerized method for determining a base budget for a particular type of project, according to one or more embodiments of the present disclosure;

FIG. 37 is an exemplary computerized method for assigning and/or modifying assignment of resources for the duration of a project, according to one or more embodiments of the present disclosure;

FIG. 38 is an exemplary computerized method for updating one or more screen displays based on input related to the base LOE for one or more disciplines involved in a project, according to one or more embodiments of the present disclosure;

FIG. 39 is an exemplary computerized method for updating one or more screen displays based on input related to distribution of project resources across the duration of a project, according to one or more embodiments of the present disclosure;

FIG. 40 is a block diagram of an exemplary user interface device, according to one or more embodiments of the present disclosure;

FIG. 41 is a block diagram of an exemplary server, according to one or more embodiments of the present disclosure; and

FIG. 42 is an exemplary computerized method for updating one or more screen displays based on input related to changes in the duration of a project, according to one or more embodiments of the present disclosure.

### DETAILED DESCRIPTION

To enable more efficient performance of normal project management activities and tasks, what is needed is a way to provide project management information in a format that is convenient and user-friendly. More specifically, what is needed is a tool that uniquely melds time, money, and resources into a fluidly adjustable set of interfaces, thereby turning the management of complex projects into an efficient process. Currently available tools fall short because address only one of these aspects. For example, certain tools may allow a user to view and manage project budgets and revenue forecasts, other tools may allow the user to view and manage project schedules, and yet other tools may allow the user to view and manage project resources. Such one-dimensional tools do not work together, require users to manually associate the information exchanged within each of the tools, and do not provide all the features needed for complex projects.

Exemplary embodiments of the present disclosure solve these and other problems and provide various exemplary advantages as described herein below. Such exemplary embodiments include a user interface device (e.g., a tablet computer) comprising a touch-sensitive display and a processor configured with application program code that provides capabilities for interactive selection and display of project management information. When executed by the processor, the application program causes the device to display first graphical information relating to a plurality of resources and to a project duration; receive a first signal indicating user modification of at least a portion of the displayed graphical information; calculate a revised allocation over the project duration for at least one of the plurality of resources; and display second graphical information based on the calculated revised allocation of resources. Embodiments also methods and non-transitory, computer-readable media embodying the procedures of the application program code described above with respect to the user interface device.

Various exemplary features and advantages of the present disclosure are explained herein in terms of displays generated or rendered by the application program (or “application”) executing on the user interface device. This explanation is not meant to limit the scope of the present disclosure, but rather to provide visual depictions that are readily comprehensible by the skilled person. Various other exemplary features and advantages of the present disclosure are explained herein in terms of flow diagrams or block diagrams, which are likewise intended to be helpful rather than limiting.

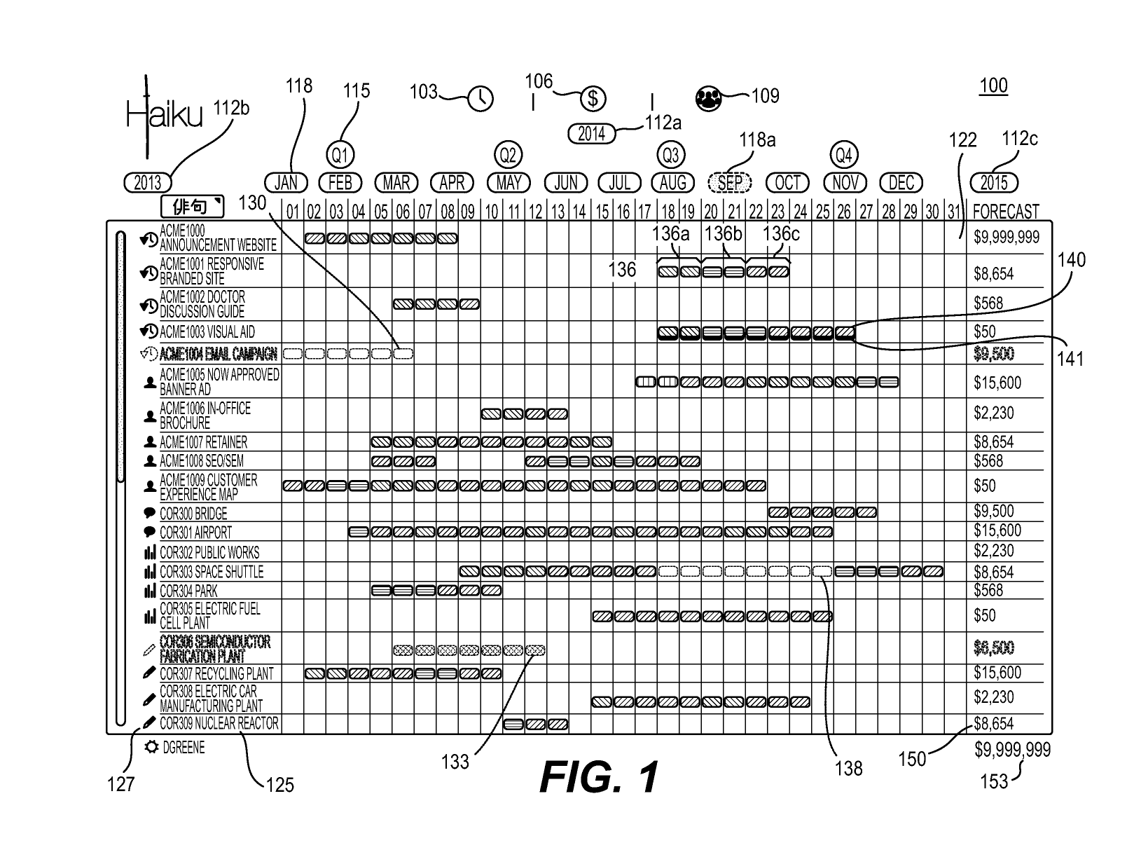

The exemplary displays presented by the application program can be broken into four main categories or views: time, money, resources, and administrative. These various categories are described below with reference to FIGS. 1 through 35. Each of the displays comprises one or more exemplary display elements, each of which corresponds to a particular type of functionality or information and occupies a clearly defined area of the respective display. In some embodiments, when a user of the user interface device touches the screen within a particular defined area, the application program receives an indicator that the user has selected the element corresponding to that defined area and executes a corresponding action, such as displaying another screen corresponding to the selected element. In some embodiments, a display element may also provide summary or high-level information related to the corresponding functionality. As described herein below, display elements may be referred to as icons, chicklets, sliders, tabs, etc.

In embodiments where the user interface device comprises a touch screen display, the user may select any display element shown in any of FIGS. 1 through 35 by touching an area on the touch screen display that corresponds to, relates to, or is associated with that display element. In these embodiments, the user may select an item from a single menu or hierarchical series of menus and/or sub-menus by dragging a finger along the screen area corresponding to the displayed menus then releasing it in the area corresponding to the final selection. Other ways of manipulating information such as that shown in FIGS. 1 through 35 in touch screen display embodiments will be apparent to persons of ordinary skill in the art.

During interaction with the user interface device, the user may apply various finger gestures to the device's touch screen display, which may cause the application to manipulate the display of various elements by, e.g., scaling (zooming), panning, rotating about an axis, etc. Any number of different single- or multi-finger gestures may be chosen to correspond to a particular manipulation, although certain choices may be preferred due to their familiarity to users of the user interface device (e.g., pinch two fingers to zoom out, spread two fingers to zoom in) or to persons of ordinary skill in the art.

In other embodiments, the user interface device may comprise a non-touch screen display and a user input device that is physically separate from the display, such as a keyboard and/or a mouse. In these embodiments, the user may select a display element by, for example, using the mouse to position a cursor over the desired element and clicking a button on the mouse to select the element, as known to persons of ordinary skill in the art. Similarly, the user may select an item from a single menu or hierarchical series of menus and/or sub-menus by dragging a finger along the screen area corresponding to the displayed menus then releasing it in the area corresponding to the final selection. Other ways of manipulating information such as that shown in FIGS. 1 through 35 in non-touch screen display embodiments will be apparent to persons of ordinary skill in the art.

In some embodiments, the application may utilize available contextual information for the user and/or the device itself to automatically determine relevant information that will be displayed to the user. For example, the contextual information may comprise the current position of the device, which may be determined using one or more available position determination technologies such as GPS, databases of WiFi access point or cell-tower locations, etc. Once known, the device position may be cross-referenced with a database of locations where the fleet unit is commonly located (e.g., bases, MR depots, etc.) to determine which, if any, of those locations the user is currently situated. This information could be used to limit or prioritize the information displayed to the user.

The determination of the relevant information based on the user's context can be performed on the device itself, or it can be performed on a server with the results communicated to the device, in a manner such that the user would not notice an impact to the execution speed of the application program. The provision of context-sensitive information could be incorporated in any of the display screens shown in FIGS. 1 through 35, as well as other display screens provided by the application program.

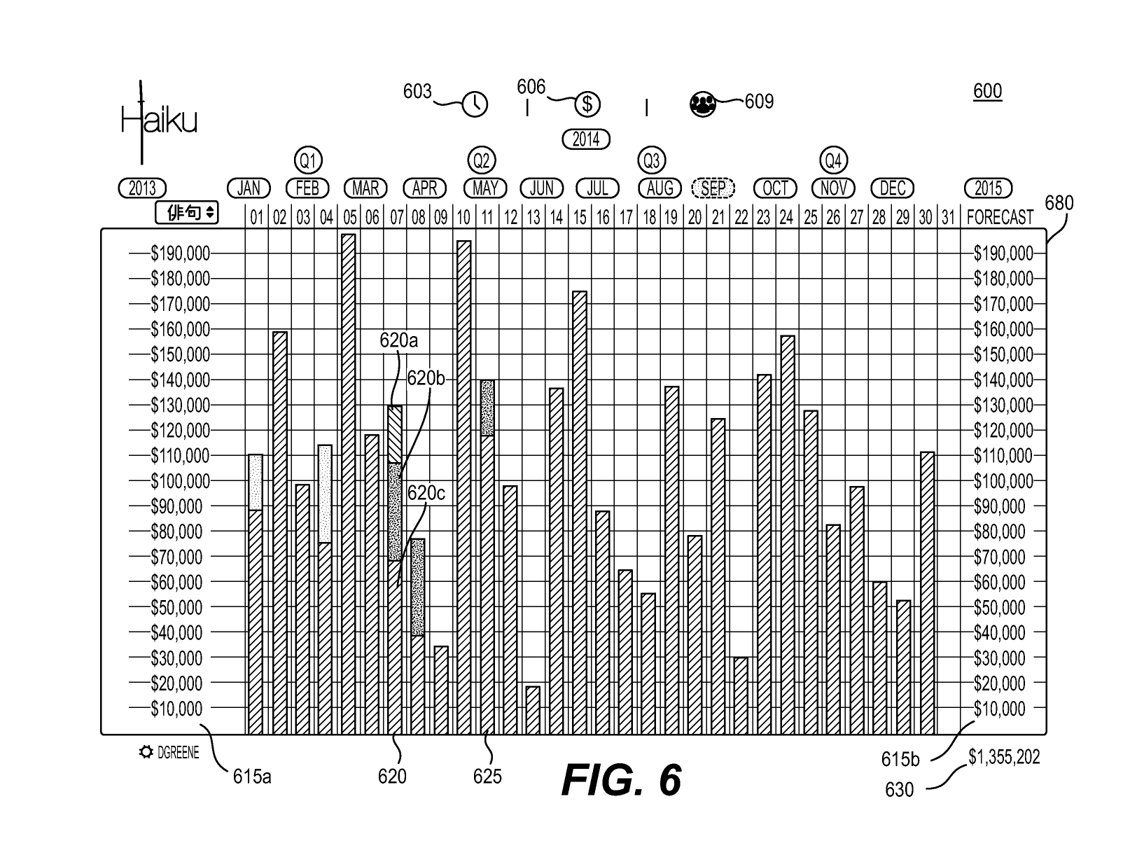

Returning to the particular screen displays, FIGS. 1 through 5 are exemplary time interface screen displays rendered by an application program executing on a user interface device, according to embodiments of the present disclosure. In some exemplary embodiments, the time interface allows for the presentation of information input via the Project Creator Tool in a Gantt chart format, where the fluidly melded financial and resource forecast data can be updatable and/or revisable via dynamic “slide-able” projects. Such techniques enable a user to update the database and the forecast for a particular client, as well as for other users of the system via additional interfaces such as the money and people (resources) interfaces described below with respect to FIGS. 6 through 9.

Display 100 in FIG. 1 comprises mode selection icons 103 (time), 106 (money), and 109 (resources). The user interface device generates display 100 upon receiving indication that the user has selected time icon 103. Display 100 generally provides the user (e.g., a project manager) with the ability to: view a client's projects across a selected period of time; view the forecast for all of the user's projects across a specified period of time; view the forecast for each project across a specified period of time; view resource constraints for each day of each project; move a project forward or backward in time, thereby adjusting the forecast accordingly and/or identifying potential resource constraints; change project duration, thereby adjusting the forecast accordingly and/or identifying potential resource constraints; experiment via project sliding to identify ideal project placement for resource and/or forecast goals.

Display 100 also includes a project grid 180 that shows all of the user's projects over a one-month period, which can be selected by using time selection icons 112a-c (years), 115a-d (quarters), and/or 118a-1 (months). An exemplary period of September 2014 is shown in display 100. The horizontal axis of grid 180 comprises a list of days 121 comprising the selected period; any date not found in the selected period (e.g., 31) can be shown as a grayed-out column (e.g., 122). The vertical axis of grid 180 comprises a list of projects 125, each of which is associated with a project icon 127. The right-most column of grid 180 comprises a list of budgetary forecasts 150, each of which corresponds to a project in list 125. A total budgetary forecast 153 also can be displayed.

The interior of grid 180 comprises a plurality of elements, each of which shows the status of a particular project during a particular day of the selected period. For example, the status may illustrated by occupancy and, if occupied, color of a grid element. Unoccupied elements indicate that no project activity is planned for that day. Occupied elements may be shown as one of various colors, e.g., gray, blue green, yellow, and red. For example, gray bar 130 indicates a project that is active, but on hold during the period. The values displayed in the forecast column and the project name column may be displayed in the same color gray, which also may be used for the same project in other displays. By further example, blue bar 133 indicates a project that is tentative, e.g., not confirmed. The values displayed in the forecast column and the project name column will be displayed in the same color blue.

Multi-color bar 136 illustrates various time conditions for an active project. For example, portion 136a indicates that the time required is at least 100% of the resource availability for those days; portion 136b indicates that the time required is between 80 and 100% of the resource availability for those days; and portion 136c indicates that the time required is less than 80% of the resource availability for those days. In exemplary embodiments comprising a full color screen display, portions 136a-c can be rendered with colors red, yellow, and green, respectively. In exemplary embodiments comprising a grayscale display, portions 136a-c may be rendered with various shades of gray. If a project has had an action occur where time has passed and then something new must be added to the project, then a supplemental can be added. The supplemental shall be connected to the original project via hollow gray chicklets (e.g., 138), indicating that time has passed. In some embodiments, there may be no action associated with selection of gray chicklets.

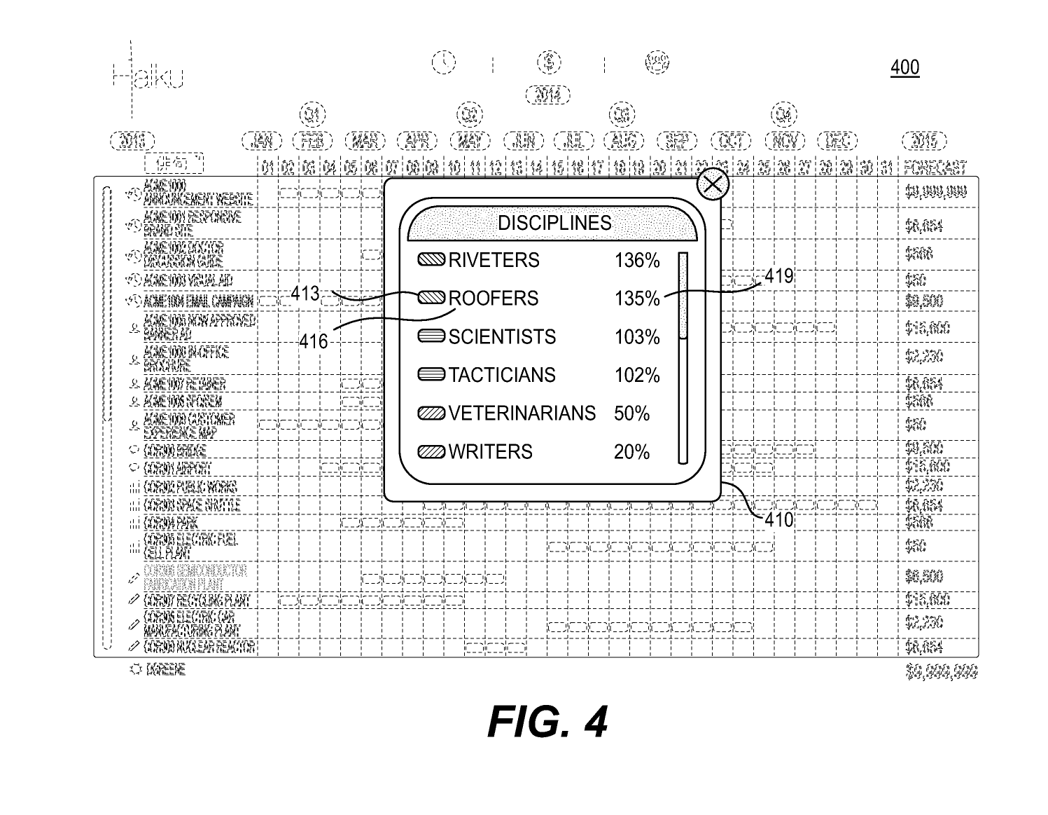

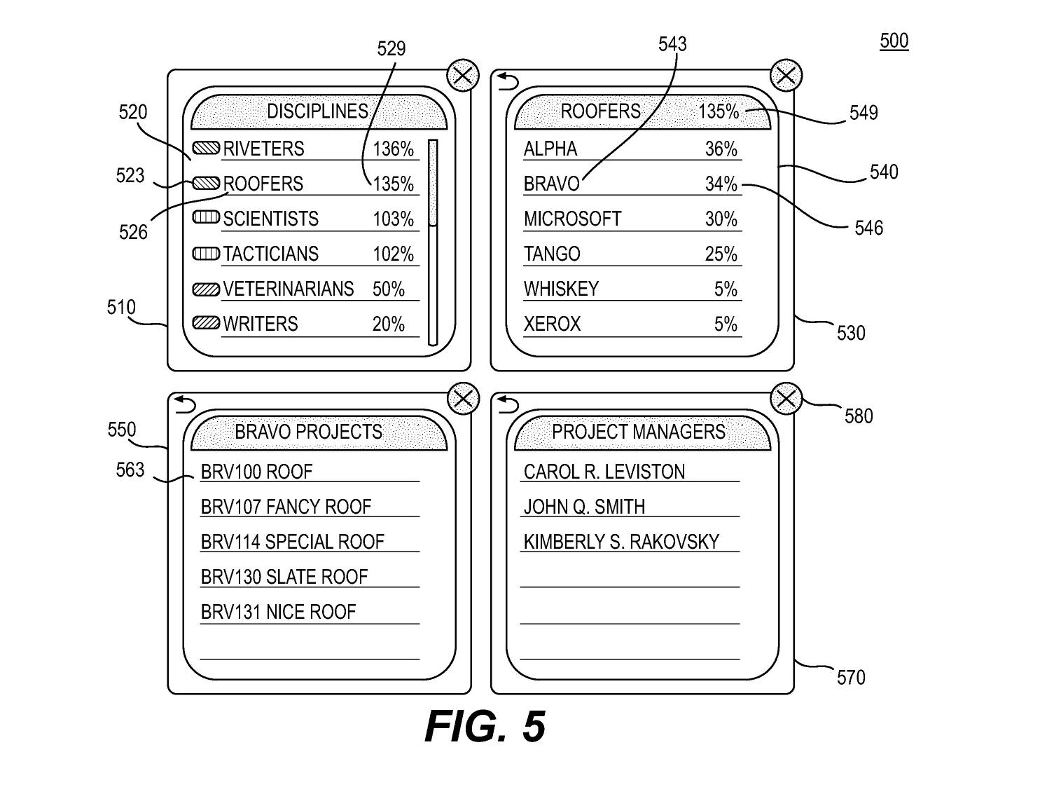

Various exemplary user manipulations of grid 180 are possible. For example, the user may increase or decrease the duration of a particular project by selecting (e.g., click and hold) the beginning or end of a colored bar (e.g., 140) and moving (e.g., dragging) the selected portion in a desired direction (e.g., left or right). By way of further example, the user may change the execution period of a particular project by selecting (e.g., click and hold) the middle of a colored bar (e.g., 140) and moving (e.g., dragging) the selected bar in a desired direction (e.g., left or right). This activity moves the project start date forward or backward in time without changing the original project duration. In some embodiments, the project duration may be moved “off-screen” to another month preceding or following the presently displayed month. Projects that have been moved or changed but have not been “saved” may display a drop shadow (e.g., 141) that has an increased opacity from the standard 10% to 75%. Other exemplary manipulations of grid 180 are described below with reference to FIGS. 4 and 5.

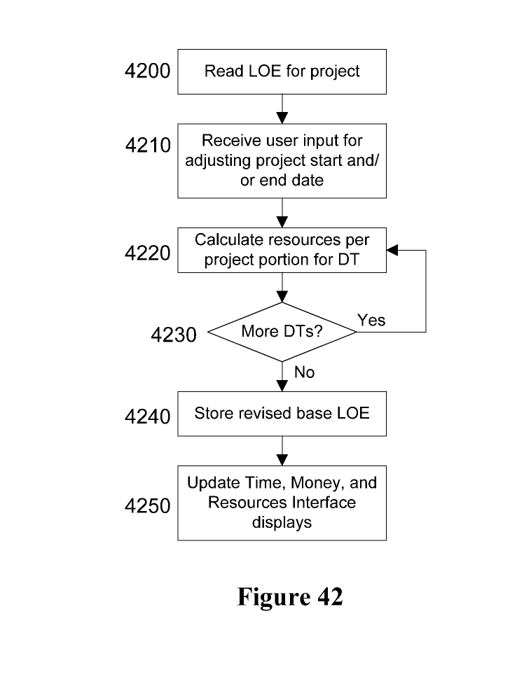

In some embodiments, the act of moving, increasing, or decreasing a project may generate a database call that may return information used by the application to update the colors in the affected project bar (e.g., representing revised resource utilization or availability levels) and/or forecast for the affected project, as described in more detail below with respect to the flow diagram shown in FIG. 42. For example, condensing a project's duration can result in the allocated hours being assigned to each resource on the project by the Creator Tool, which can be shaped across the project's duration by the graphic equalizer control, e.g., the allocated hours will be assigned to fewer days, thereby increasing the resource needs on each day, and, in-turn, increasing the financial forecast for each day. Moreover, this can result in a corresponding impact to the financial forecast on the Money Interface and to the resource needs as applied to all applicable instances within the Resources Interface. By way of further example, moving a project duration at least partially into a different month can result a revised project financial forecast for the affected months.

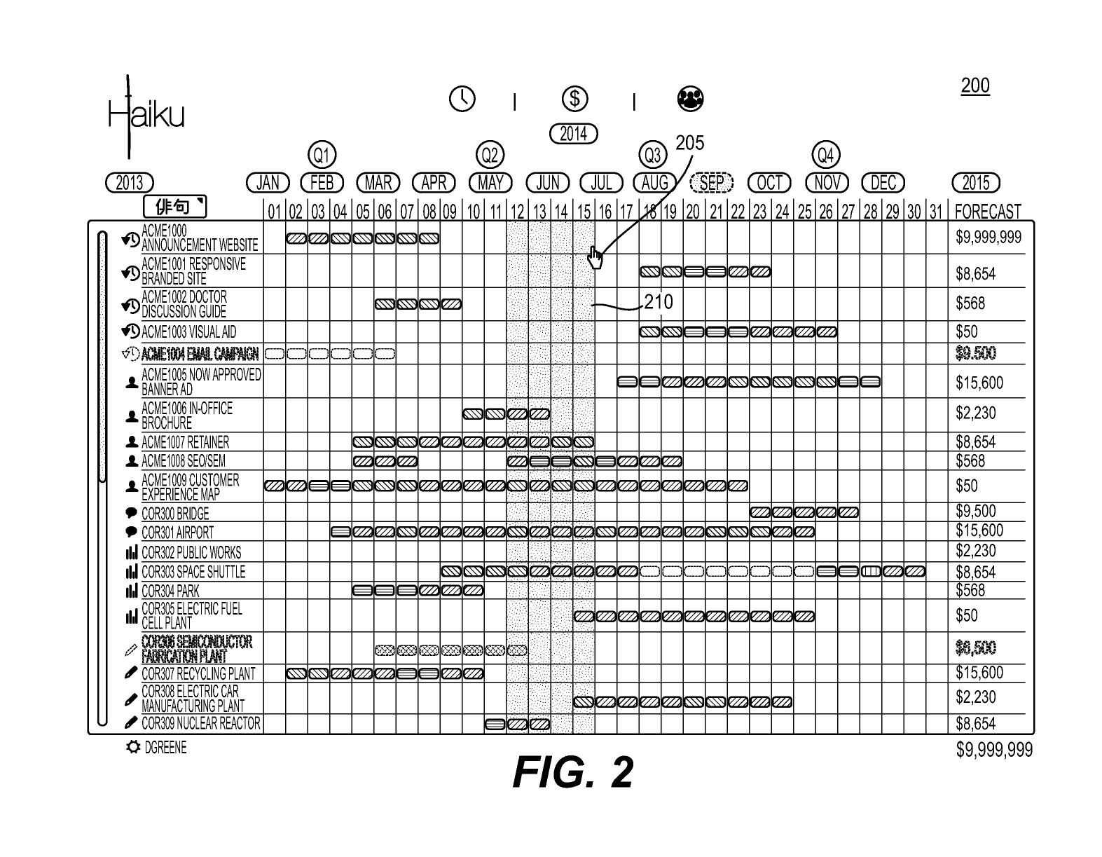

FIG. 2 is another exemplary time interface screen display rendered by an application program executing on a user interface device, according to embodiments of the present disclosure. Display 200 includes many of the same elements as display 100 shown in FIG. 1. In addition, display 200 includes a selection tool 205 that be used to select a particular date range, e.g., range 210, by clicking and dragging across consecutive horizontal grid elements in the desired date range. In some embodiments, selection of date range may generate a database call that may return information used by the application to update the forecast totals to reflect the highlighted date range. In some embodiments, selection of another portion of the screen may cause the selected range 210 to become unselected, thereby generating another database call that may return information used by the application to revert the forecast data to the full period.

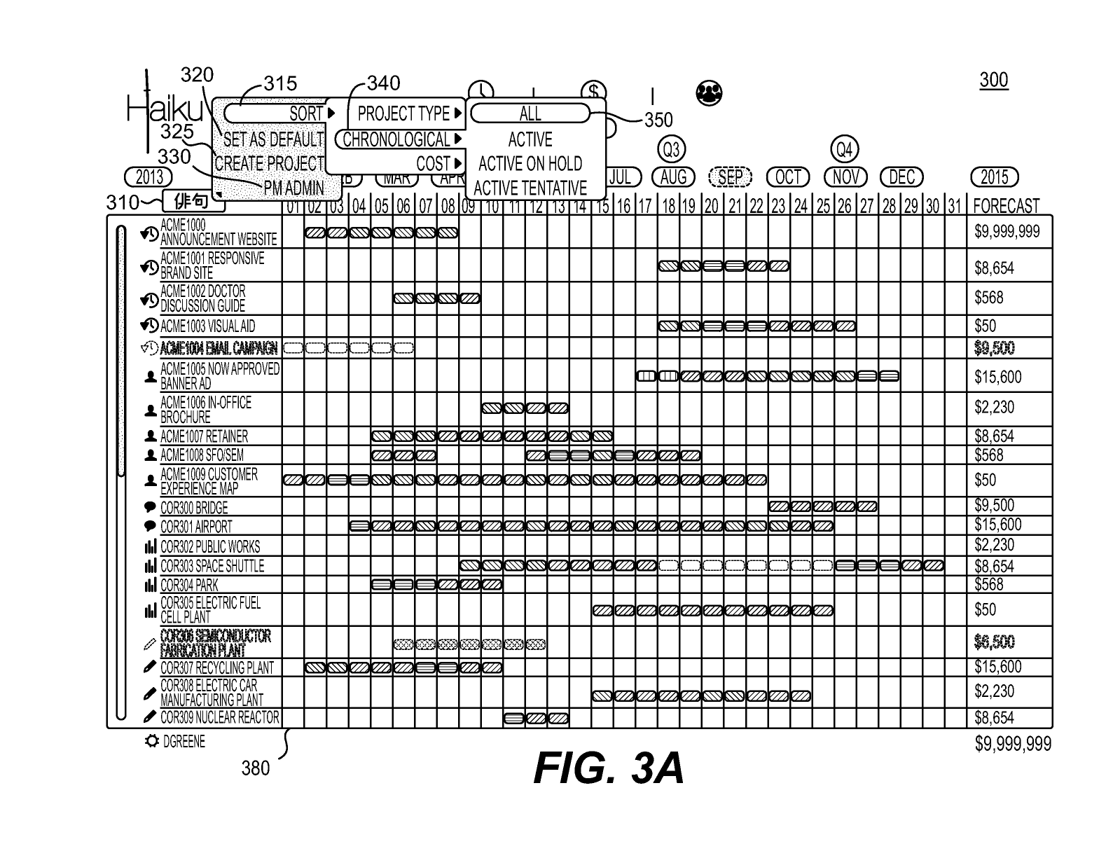

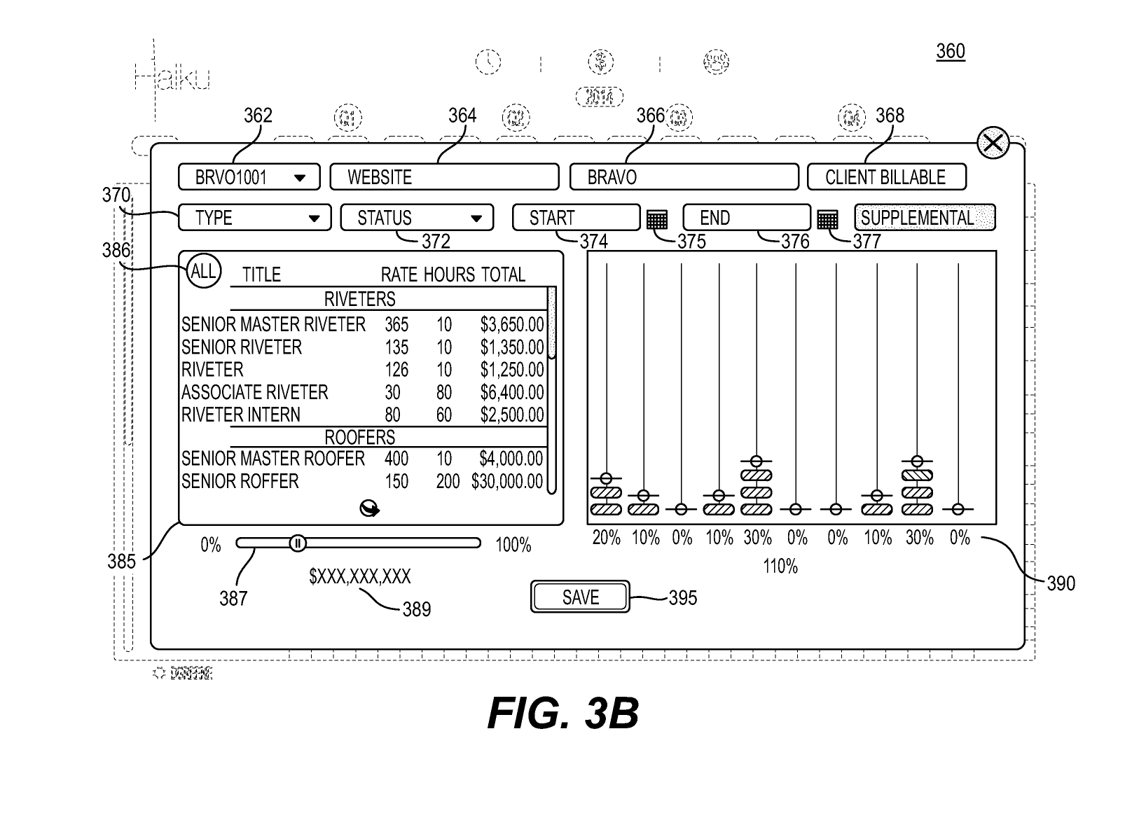

FIG. 3a is another exemplary time interface screen display rendered by an application program executing on a user interface device, according to embodiments of the present disclosure. Display 300 includes many of the same elements as display 100 shown in FIG. 1. In addition, display 300 includes a command icon 310. When a user touches command icon 310, the application program displays a primary menu of various command and sort options including Sort 315, Set as Default 320, Create Project 325, and PM Admin 330. Selection of Sort 315 may cause the application to display a secondary menu of sort options including, for example, chronological, by project type, and by project cost. Selecting one of these options, e.g., Chronological 340, may cause the application to display a tertiary menu of project sort options including All 350, Active, Active On Hold, and Active Tentative. The application can sort the list of projects in grid 380 according to the selections from the secondary and tertiary menus.

In addition, primary menu option Set as Default 320 allows the user to set the current parameters of the Time interface to be the default view upon login, while Create Project 325 may cause the application to open the Project Create Modify Tool, described in more detail below. Similarly, selection of PM Admin 330 may cause the application to open a modified version of the Project Create Modify Tool, where the user can set a new base budget with weighted LOE to be used on all future project types (i.e. all web sites) for a specific client.

FIG. 3b is another exemplary time interface screen display rendered by an application program executing on a user interface device, according to embodiments of the present disclosure. In particular, display 360 illustrates an exemplary project creation display in response to a user selection of command icon 310 and Create Project 325 option shown in display 300 of FIG. 3a. Display 360 comprises a project code selection tool 360, which if selected by the user can cause the application to display a list of project codes already known to the application. User selection of a particular code from the list can cause the application to display project code information fields 364, 366, and 368, and to activate project type tool 370, project status tool 372, start date field 374, start date icon 375, end date field 376, and end date icon 377. Selection of tool 370 can cause the application to display a list of project types already known, from which the user can select a particular type. Selection of tool 372 can cause the application to display a list of project status types, e.g., Active, On-hold, and Tentative, from which the user can select a particular status. The user may enter a start (end) date for the worker textually in field 374 (376) or by selecting icon 375 (375), which may cause the application to display a calendar field from which the user may further select a start (end) date.

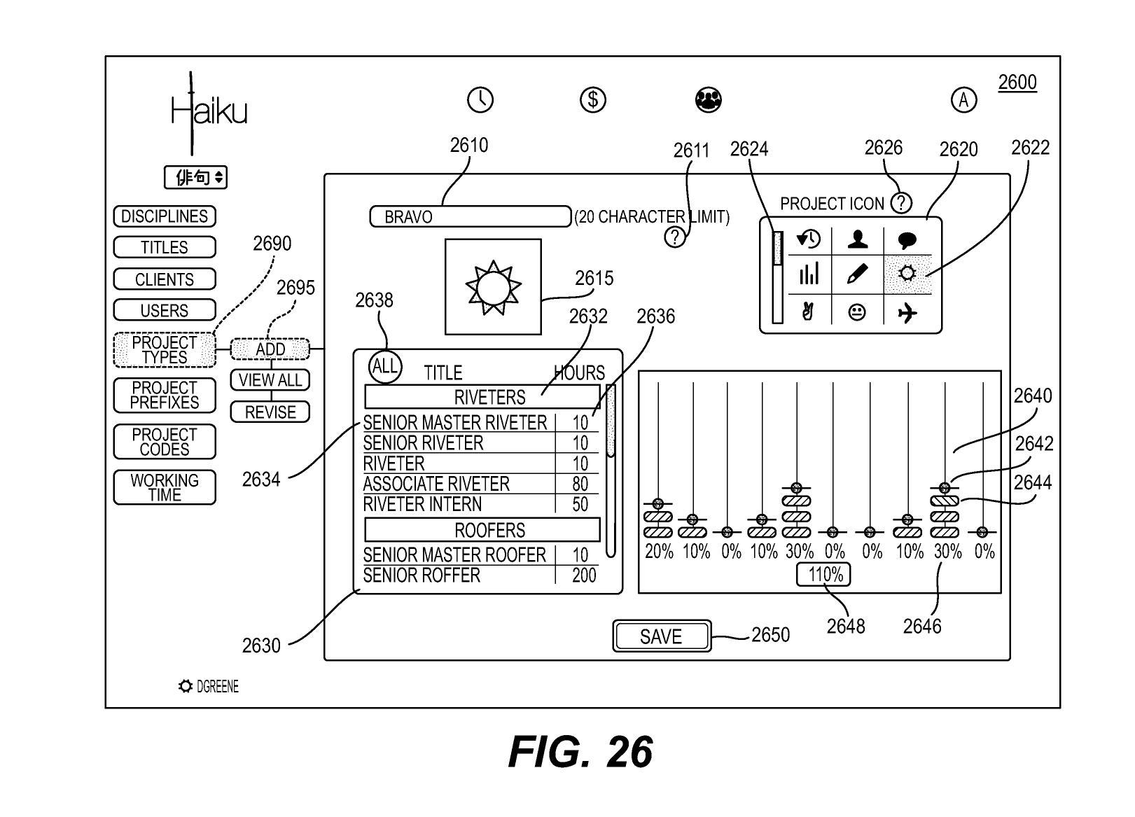

Selection of a particular project type can cause the application to display budget tool 385, All control 386, graphic equalizer tool 390, and save icon 395. In some embodiments, the appearance and operation of fields 385, 386, 390, and 395 can be substantially similar to fields 2630, 2638, 2640, and 2650, respectively, of display 2600, as described in more detail below with reference to FIG. 26. Selection of a particular project type can also cause the application to display budget total field 389, which comprises a sum of budgeted project revenues for each of the discipline-types (DTs) listed in field 385. Display 360 also includes a slider control 387, which enables the user to change the project hours of a selected DT or of the all DTs included in the project type, depending on the setting of the All control 386. In response to user input moving slider control 387 left or right, the application can increase or decrease, respectively, the project hours displayed in field 385. Slider control 387 may comprise a default setting (e.g., 100%), a minimum setting (e.g., 0%), and/or a maximum setting (e.g., 400%).

In other exemplary embodiments, display 360 may be modified to permit the user to modify the parameters (e.g., adjust the base LOE and weight it across time for project types) of a project or project type subsequent to creation. The application may present such a display, for example, in response to a user selection of command icon 310 and PM Admin 330 option shown in display 300 of FIG. 3a. In such alternative embodiments, the display screen can comprise a client selection tool which, if selected by a user, will cause the application to display a drop-down menu of clients. Selection of a particular client can cause the application to activate a type control, similar in appearance and operation of control 370 shown in FIG. 3b. Selection of type control and a project type can cause the application to display fields such as budget tool 385, graphic equalizer control 390, and save control 395 shown in FIG. 3b. The user can employ such controls to modify and save the project information in substantially the same manner as described above. Depending on embodiment, the information initially displayed (e.g., prior to modification) in the budget tool 385 and graphic equalizer control 390 after selection of a client and a project type can be either the base weighted LOE or the last stored modification to the weighted LOE.

FIG. 4 is another exemplary time interface screen display rendered by an application program executing on a user interface device, according to embodiments of the present disclosure. In particular, display 400 illustrates an exemplary display of information in response to a user selection of a grid element (e.g., element of grid 180 in FIG. 1) corresponding to an active project. In some embodiments, such selection may cause the application to display all disciplines assigned to the project in order of ascending allocation; with ties broken alphabetically. This may occur, e.g., via a light box 410 in the foreground and the main time interface screen fading into a blur in the background, as shown in FIG. 4. Each of the disciplines (e.g., 416) shown in box 410 is associated with a color (e.g., 413) indicating allocation vs. capacity. For example, red may indicate greater than 100% capacity, yellow may indicate greater than or equal to 80% and less than or equal to 100%, and green may indicate less than 80%. The cell color may be based on at least one discipline assigned to the project meeting the capacity qualifications. The capacity of each discipline also may be displayed numerically (e.g., 419).

Upon selection of a discipline shown in display 400, the box 410 will be replaced with new information. FIG. 5 shows various exemplary boxes that may be displayed in the same manner as box 410 in FIG. 4. Box 510 is substantially the same as box 410. If the user selects a discipline (e.g., “Roofers”) by clicking on the corresponding area in box 510, the application program replaces box 510 with box 530 that shows a list of clients to which the selected discipline is assigned or allocated. Each client (e.g., “Bravo” 543) in the list is associated with a percentage of the discipline assigned to that client (e.g., 546). The sum of these values (549) is identical to the numerical capacity of the discipline displayed in box 510. Upon selection of a particular client (e.g., 543), the application replaces box 530 with box 550 showing all projects associated with the selected client and selected discipline. Upon selection of a particular project (e.g., 563), the application replaces box 550 with box 570 showing all project managers associated with the selected project. Alternately, the user may exit from display of any of boxes 510-570 by selecting the exit icon 580.

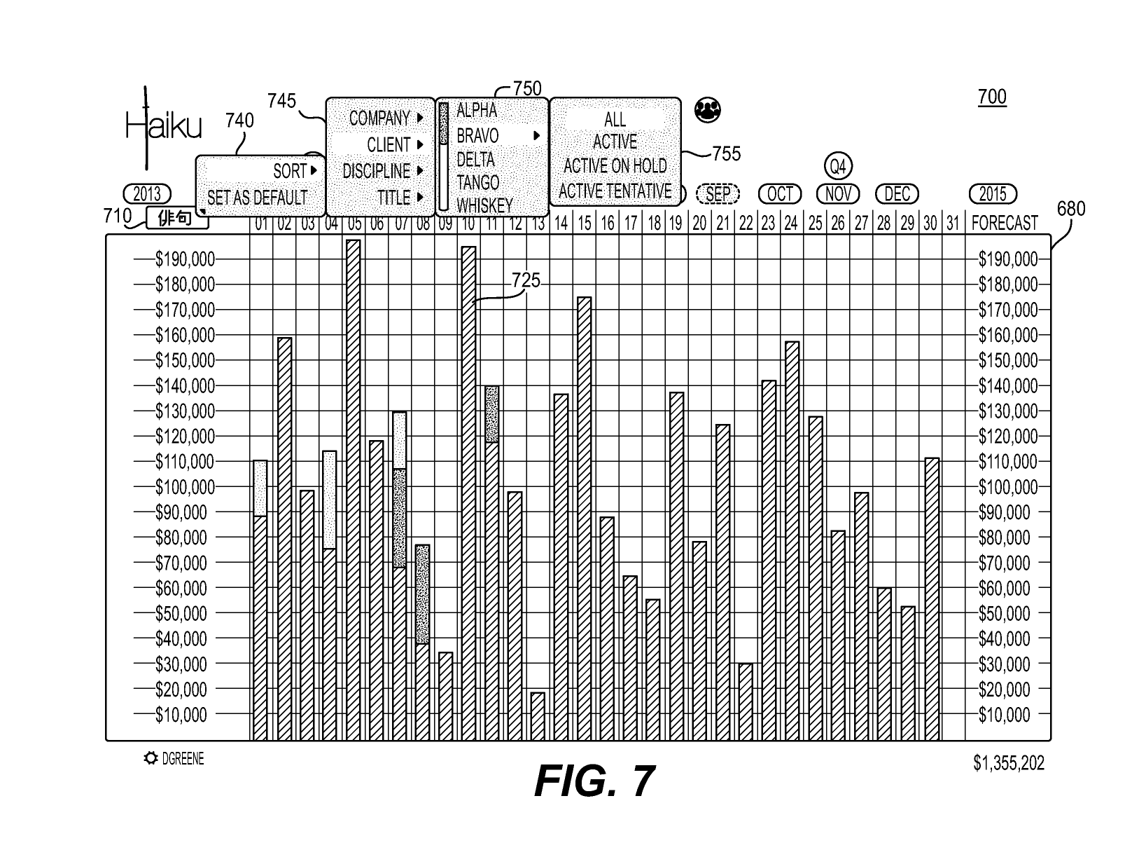

FIGS. 6-7 are an exemplary money interface screen displays rendered by an application program executing on a user interface device, according to embodiments of the present disclosure. In some exemplary embodiment, the money interface allows for the presentation of financial forecasts resulting from one or more projects created by a particular user, or by all users. In some embodiments, the shaping of resource hours (and projected income derived therefrom) across time via the graphic equalizer control of the Project Creator Tool described below with respect to FIG. 26 enables the application to determine a financial forecast (dollar amount) for the company in the Money Interface described below. In some embodiments, a financial forecast can be sorted across disciplines, groups, and individuals within the company database.

Display 600 in FIG. 6 comprises mode selection icons 603 (time), 606 (money), and 609 (resources). The user interface device generates display 600 upon receiving indication that the user has selected money icon 606. Display 600 generally provides the user (e.g., a project manager) with the ability to: view one or more exemplary labor-related revenue forecasts during a selected period of time; and set different forecast parameters via a sort/filter function. Such exemplary revenue forecasts may be generated by application by database calls according to the sort/filter parameters and by computations based on labor hours and billing rates according to the sort/filter parameters. To the extent that display 600 includes substantially similar elements as display 100, descriptions of these will be omitted hereinafter.

Display 600 includes a grid 680 that shows revenue for the user's projects over a one-month period, which can be selected by using time selection icons as described above. An exemplary period of September 2014 is shown in display 600. The horizontal axis of grid 680 comprises the days comprising the selected period; any date not found in the selected period (e.g., 31) can be shown as a grayed-out column. The vertical axis of grid 680 comprises a revenue axis, with a set of vertically increasing values on the left- and right-hand side of grid 680 (615a and 615b, respectively). A total revenue forecast 630 for the selected period also may be displayed.

Each of the vertical bars represents total revenue during a particular day of the selected period. The status of revenue for a particular day may be indicated by the color of the corresponding vertical bar, or portions thereof. For example, vertical bar 620 comprises portions 620a, 620b, and 620c. The grey color of 620a indicates revenue from work that is on hold; the blue color of 620b indicates revenue from work that is tentative (e.g., not confirmed); and the green color of 620c indicates revenue from work that is neither on hold nor tentative.

Display 700 of FIG. 7 includes many of the same elements as display 600 shown in FIG. 6. In addition, display 700 includes a command icon 710. When a user touches command icon 710, the application program displays a primary menu 740 of various command and sort options including Sort and Set as Default. For example, selection of Sort may cause the application to display a secondary menu 745 of sort options including Company, Client, Discipline, and Title. By further example, selecting one of these options, e.g., Client, may cause the application to display a tertiary menu 750 of client options. Selecting one of these client options, e.g., “Bravo”, may cause the application to display a quaternary menu 755 of project options including All, Active, Active On Hold, and Active Tentative. In some embodiments, the application may display project revenue in grid 680 according to the selections made from menus 740-755.

Various exemplary user manipulations of grid 680 are possible. For example, the user may select (e.g., click or click and hold) a particular vertical revenue bar (e.g., 725). The application will display particular information based upon one or more selections made from menus 740-755. For example, if “Company” is the selected sort then the application will display (e.g., in a box) the revenue by client and, in some embodiments, a total revenue. If “Discipline” is the selected sort then the application will display the revenue by discipline (e.g., plumber) and, in some embodiments, a total revenue. If “Title” is the selected sort then the application will display the revenue by client and, in some embodiments, a total revenue. The skilled person will recognize that these displays are merely exemplary and the application may be configured to display alternative or additional information according to selections made from menus 740-755.

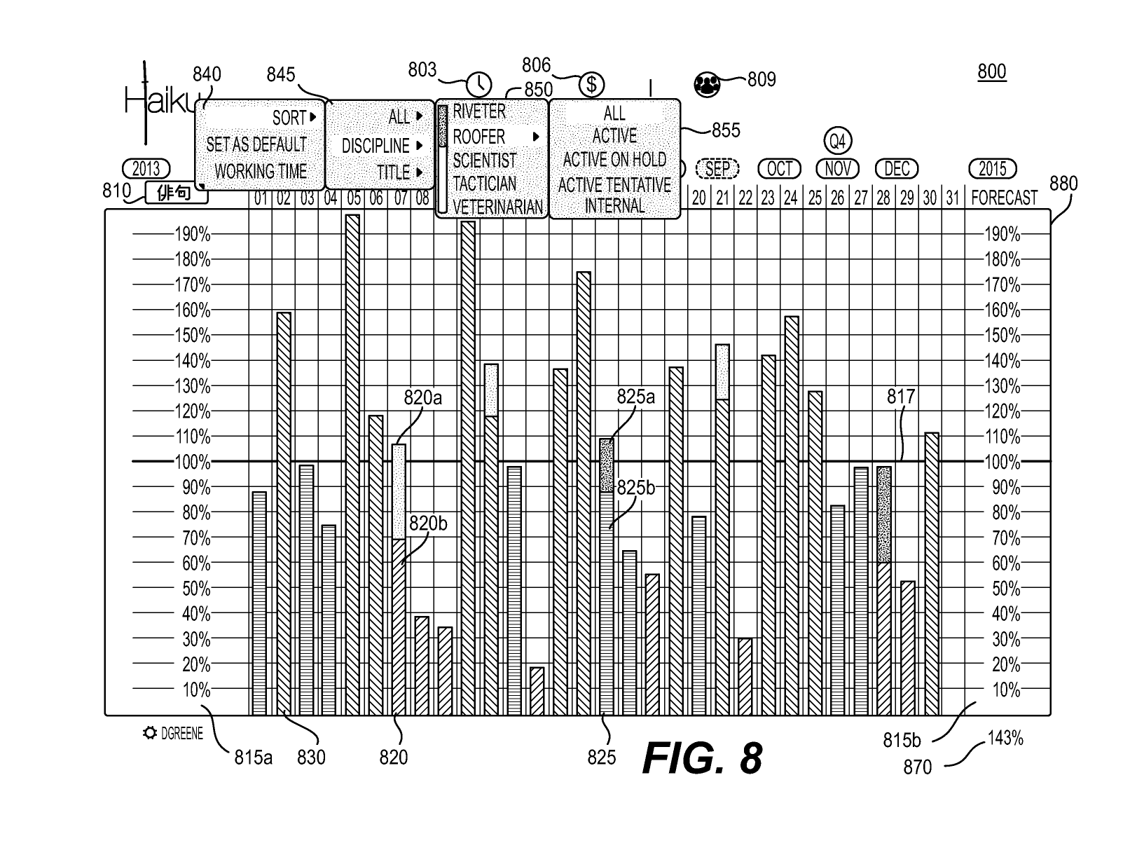

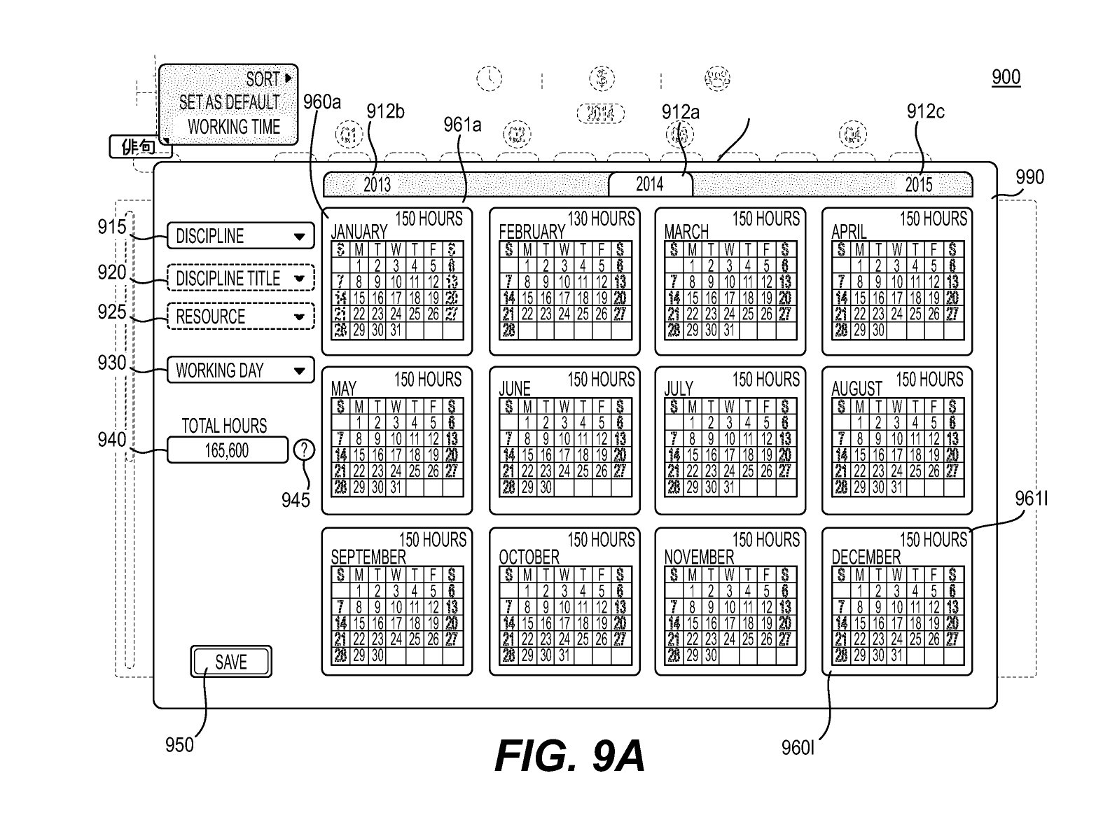

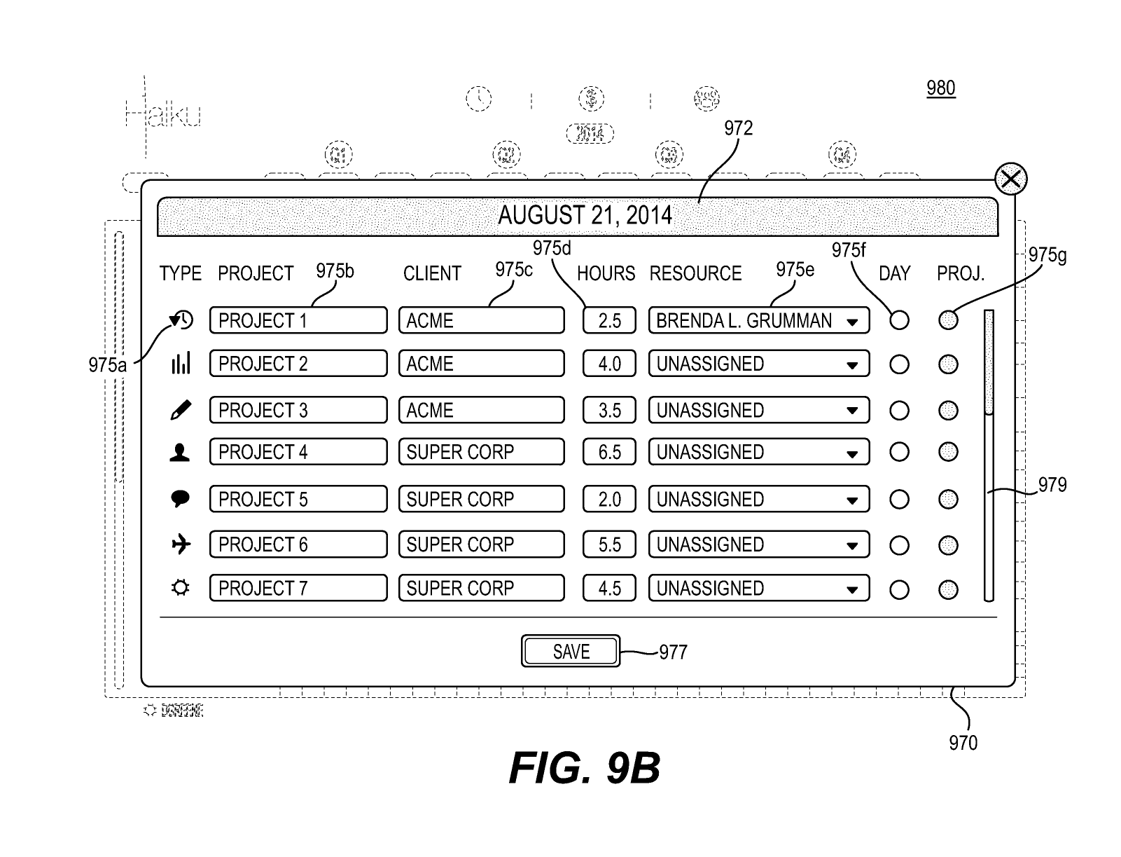

FIGS. 8, 9a, and 9b are exemplary resources interface screen displays rendered by an application program executing on a user interface device, according to embodiments of the present disclosure. In some exemplary embodiment, the resources interface allows for the presentation of resource forecasts resulting from one or more projects created by a particular user, or by all users. In some embodiments, the application uses the workable time input to determine resource capacity, resulting in a visual comparison of resource need vs. capacity via the resources interface. In some embodiments, the shaping of resource hours (and projected income derived therefrom) across time via the graphic equalizer control of the Project Creator Tool described below with respect to FIG. 26 enables the application to determine a resource forecast (e.g., hours, utilization vs. capacity) for the company in the resources interface described below. In some embodiments, resource forecasts can be sorted across disciplines, titles, and individuals within the company database.

Display 800 in FIG. 8 may comprise mode selection icons 803 (time), 806 (money), and 809 (resources). The user interface device generates display 800 upon receiving indication that the user has selected resources icon 809. Display 800 generally provides a user (e.g., project manager) with the ability to: view labor-related forecasts across a selected period of time; set various forecast parameters via the sort/filter function; and set working time for disciplines at the Discipline, Title, and Resource levels; Such exemplary labor forecasts may be generated by application by database calls according to the sort/filter parameters and by computations based on labor hours and billing rates according to the sort/filter parameters. To the extent that display 800 includes substantially similar elements as display 100, descriptions of these will be omitted hereinafter.

Display 800 includes a grid 880 that shows resource utilization vs. capacity for the user's projects over a one-month period, which can be selected by using time selection icons as described above. An exemplary period of September 2014 is shown in display 800. The horizontal axis of grid 880 comprises the days comprising the selected period; any date not found in the selected period (e.g., 31) can be shown as a grayed-out column. The vertical axis of grid 880 comprises a percentage utilization axis, with a set of vertically increasing values on the left- and right-hand side of grid 880 (815a and 815b, respectively). The range of values comprising the vertical axis may be determined, for example, based on the minimum and maximum utilization values for the selected period. In some embodiments, a 100% capacity line 817 may be displayed. A total percentage utilization forecast 870 for the selected period also may be displayed.

Each of the vertical bars represents resource utilization during a particular day of the selected period. The utilization percentage for a particular day may be indicated by the color of the corresponding vertical bar, or portions thereof. For example, vertical bar 820 comprises portions 820a and 820b and vertical bar 825 comprises portions 825a and 825b. For example, red may indicate utilization greater than 100% capacity, yellow may indicate utilization greater than or equal to 80% and less than or equal to 100%, and green may indicate utilization less than 80%. Moreover, gray may indicate utilization due to work that is on hold, while blue may indicate utilization due to work that is tentative, e.g., not confirmed. In some embodiments, neither the on-hold nor the tentative work is used to determine the color corresponding to the utilization percentage (e.g., green, yellow, or red).

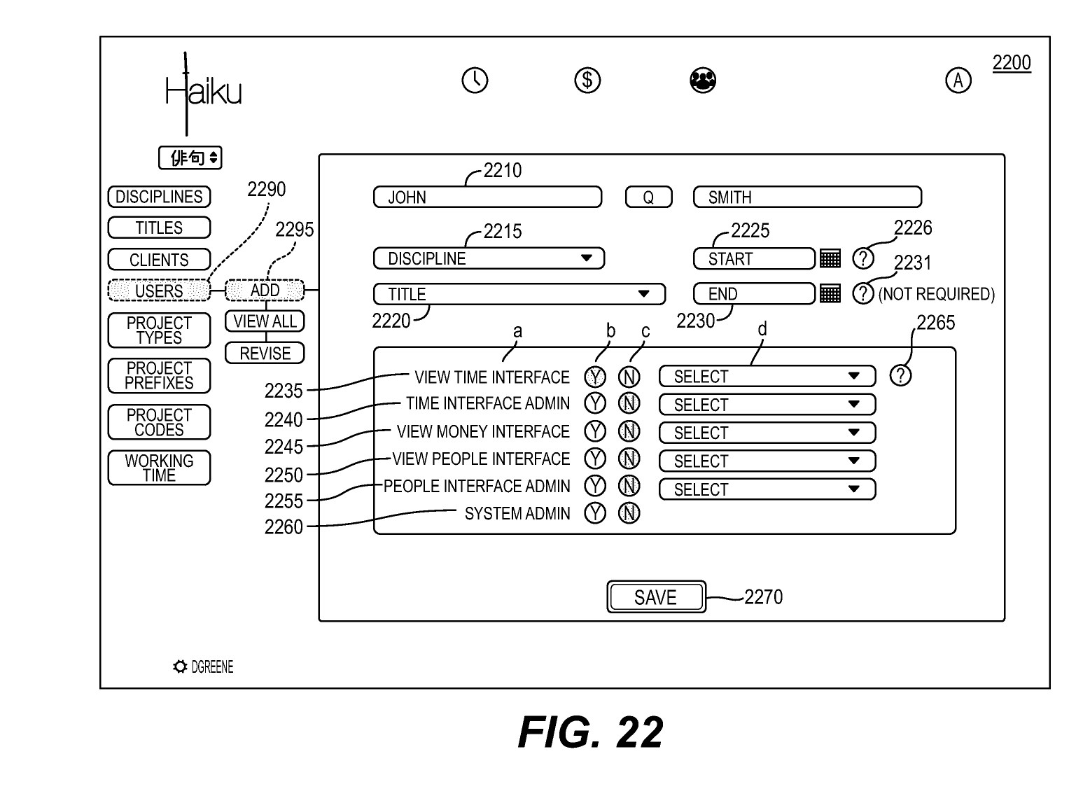

Display 800 also includes a command icon 810. When a user touches command icon 810, the application program displays a primary menu 840 of various command and sort options including Sort, Set as Default, and Working Time. In some embodiments, primary menu 840 may further comprise an Assign Resources option, depending on whether the user has been given administrator privileges for the People (Resources) interface, as described below with reference to FIGS. 22-25. Selection of the Sort option may cause the application to display a secondary menu 845 of sort options including Discipline and Title. By further example, selecting one of these options, e.g., Discipline, may cause the application to display a tertiary menu 850 of client options. Selecting one of these client options, e.g., Discipline, may cause the application to display a quaternary menu 855 of project options including All, Active, Active On Hold, and Active Tentative. In some embodiments, the application may display utilization information in grid 880 according to the selections made from menus 840-855.

In addition, selection of primary menu 840 option Set as Default allows the user to set the current parameters of the resources interface to be the default view upon login. Likewise, selection of primary menu 840 item Working Time allows the user to set working time for any Discipline, Title, or Resource under the user's responsibility. In some embodiments, this can be done via a Calendar Tool, described in more detail below. Similarly, selection of PM Admin 330 may cause the application to open a modified version of the Project Create Modify Tool, where the user can set a new base budget with weighted LOE to be used on all future project types (i.e. all web sites) for a specific client.

Various exemplary user manipulations of grid 880 are possible. For example, the user may soft-select (e.g., mouse-over) a particular vertical utilization bar (e.g., 825). In response, the application may display the utilization percentage and total hours for the day corresponding to the vertical bar. By further example, the user may select (e.g., click or click and hold) a particular vertical utilization bar (e.g., 825). In response, the application may display a light box comprising per-client utilization information corresponding to the selected vertical bar. For example, this information may be displayed in a format similar to the display of discipline information in box 410 of FIG. 4. Upon selection of a particular client from the list, the application may display a different light box comprising information about all Projects and Hours associated with that client during the selected time period (e.g., in ascending order with most hours listed first). Upon selection of a project, the application may display a different light box comprising a list of Project Manager(s) assigned to the selected Project. The display of different boxes according to further menu selections may be done in a manner similar as described with respect to FIG. 5.

FIG. 9a is another exemplary resources interface screen display rendered by an application program executing on a user interface device, according to embodiments of the present disclosure. In particular, display 900 of FIG. 9a shows a screen display rendered by the application in response to the user selecting Working Time from menu 840 described above. Display 900 may include a calendar box 990, which may be rendered in a manner similar to box 410 shown in FIG. 4. Calendar box 990 may include various date-related fields including year fields 912a-c and month fields 960a-1. User selection of a year field (e.g., 912a) may cause the application to display the month fields 960a-1 corresponding to the selected year. Each month field comprises the appropriate number of days arranged, e.g., in a weekly format, with working and non-working days distinguished by color. For example, each day designated by blue font with a white background may be considered Working Time, while each day designated by gray front with a gray background may be considered Non-Working Time. Only Working Time will be factored into any calculations that determine Resource Hours and Company Horus. A user may change a Working Time day into a Non-Working Time day by selecting the corresponding area in the month field. Each month field 960a-1 is associated with a total monthly working time field (961a-1, respectively); these fields will be updated according to changes to Working and Non-Working days in the respective months. In some embodiments, default Working (e.g., Monday-Friday) and Non-Working (e.g., Saturday and Sunday) days may be provided in the month fields.

Display 900 of FIG. 9a also includes various drop-down menu tools 915-930 for controlling the display of box 990. For example, discipline tool 915 enables the user to select the specific discipline for which working time can be edited. In addition, discipline title tool 920 enables the user to select the specific title in the selected discipline for which working time can be edited. Discipline title tool 920 may be ghosted until the user selects a Discipline, at which time it will become active with titles appropriate to the selected discipline. Resource tool 925 further enables the user to select from among resources having the selected title(s) for editing of working time for these specific resources. In one or more of these menus, choices may include “All” as well as particular enumerated disciplines, titles, and/or resources, which may be listed in alphabetical and/or numerical order. Display 900 also includes a total hours field 940, whose value is the sum of all hours (e.g., the capacity) for a discipline, title, or resource selected using tools 915-925. The application may calculate the displayed value by the product of the number of working days, the workable hours per a day (selectable, e.g., using hours-per-day tool 930), and the number or working days per year, updating the value according to changes made to the various fields. Fields 930 and 940 may have associated help icons 935 and 945, respectively; selection of a help icon may cause the application to display additional information concerning the associated field. Finally, display 900 may comprise a save control 950, the selection of which may cause the application to save changes made using other fields of display 900.

FIG. 9b is another exemplary resources interface screen display rendered by an application program executing on a user interface device, according to embodiments of the present disclosure. In particular, display 980 of FIG. 9b shows a screen display rendered by the application in response to the user selecting the Assign Resources option from menu 840 associated with command icon 810, as described above. The user may perform such selection in order to assign resources from one or more resources, titles, and/or disciplines over which the user has supervisory authority. Display 980 may include a resource assignment box 970, which may be rendered in a manner similar to box 410 shown in FIG. 4. Resource assignment box 970 may comprise a header bar 972 that displays the date that a user previously selected using one or more other displays of the People (Resources) Interface. Resource assignment box 970 may further comprise a list of projects that require capacity to be allocated by the user, e.g., projects that include a day of duration on the date selected and have a predetermined resource need. Each project in the list may be represented by several fields such as fields 975a-g that represent Project 1 in display 980. If there are more projects than display space in box 970, the application may provide a slider control 979 so that the user can view the entire list.

Fields 975a-c display type, name, and client information that is currently associated with Project 1. Field 975d displays the number of hours required for Project 1 from the particular discipline or title. Field 975e comprises a resource selection tool, which if selected by the user may cause the application to display a list of resources selectable by the user to fulfil the project requirement. Each of the selectable resources may be color-coded according to their availability and/or utilization for the particular date. In some embodiments, the color-coding scheme described herein (e.g., red, yellow, green, etc.) with respect to other aspects can be employed for this purpose. Selection of a particular resource may cause the application to display the selected resource in field 975e (e.g., Brenda L. Guzman). Fields 975f-g are user-selectable fields that enable the user to select whether the resource assignment shown in 975e is valid only for that day (e.g., Aug. 21, 2014) or for the entire project. Only one of 975f and 975g may be selected for each control, e.g., they are mutually exclusive. Display 980 may also comprise a save control 977, the selection of which may cause the application to save changes made using other fields of display 980.

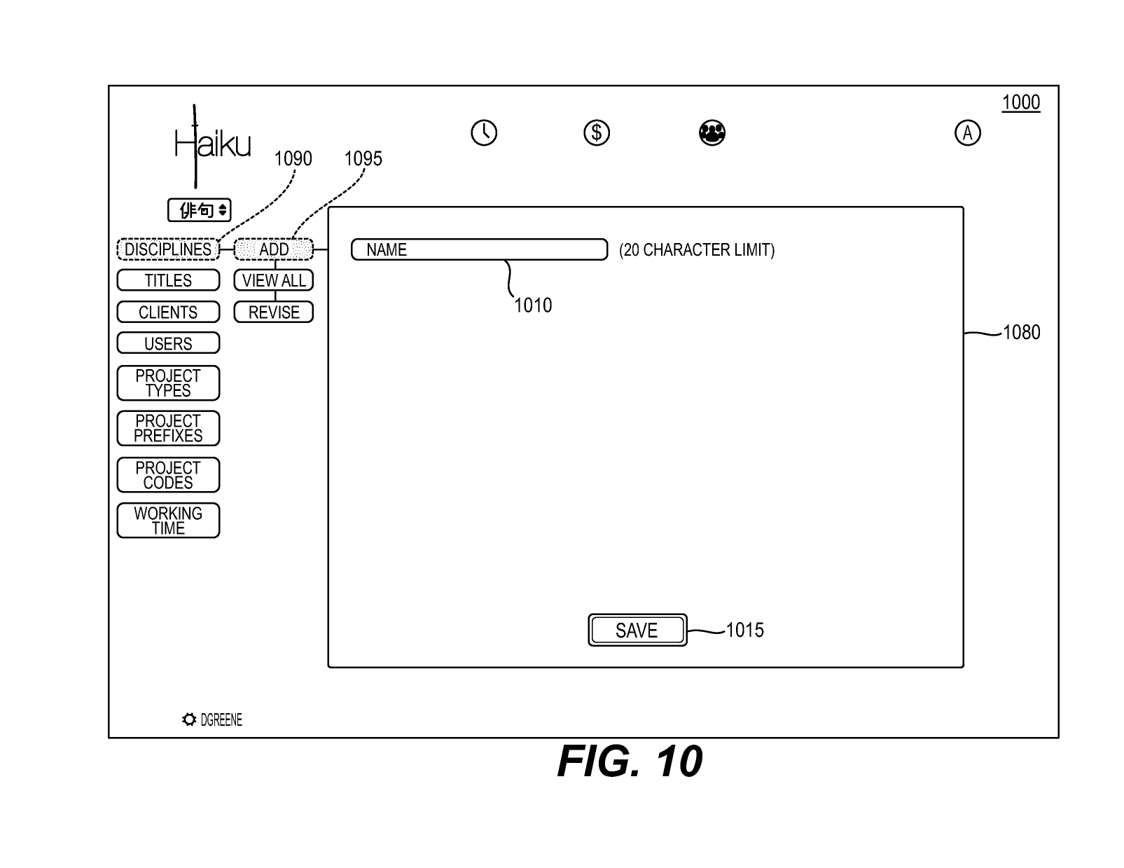

FIGS. 10-34 are various administrative screen displays rendered by an application program executing on a user interface device, according to various embodiments of the present disclosure. Such screen displays may only be accessible, for example, to users with the proper credentials, which may be identified upon login. Administrative capability may be indicated, for example, by the presence of a particular icon, which may be selected by the user to invoke administrative functionality of the application. After selection, the application may change the appearance of the icon to indicate an administrative mode. The administrative screen displays may be utilized to control inputs required for end users to utilize the time, money, and resources interface screen displays (e.g., FIGS. 1-9), as well as the Project Creator/Modifier Tool described herein below. These inputs may relate to, for example, disciplines, titles, clients, users, project types, project prefixes, project codes, and working time. In some embodiments, the administrative screen displays may comprise a menu and one or more sub-menus of administrative options related to these inputs. Such menus may comprise a list of options in textual or iconic form, ordered preferably in an order that an administrator would follow during a setup phase.

FIG. 10 is an exemplary administrative screen display for adding a new discipline, according to one or more embodiments of the present disclosure. Display 1000 illustrates an exemplary primary navigation menu of administrative options corresponding to the setup options described above. In some embodiments, upon selection of a particular option (e.g., disciplines 1090), the application may change the color of the icon corresponding to the selected option and may render a line to the secondary option menu. The user may further select an option in the secondary menu (e.g., Add 1095), which may cause the application to change the color of the icon corresponding to the selected option. Display 1000 may also include a working box 1080 that may further include fields such as discipline name field 1010. After the user selects field 1010 and enter text representing the new discipline, the user may further select save control 1015, which may cause the application to save the entered text. If the entered text is not valid, the application may display appropriate error message(s) upon attempt to save.

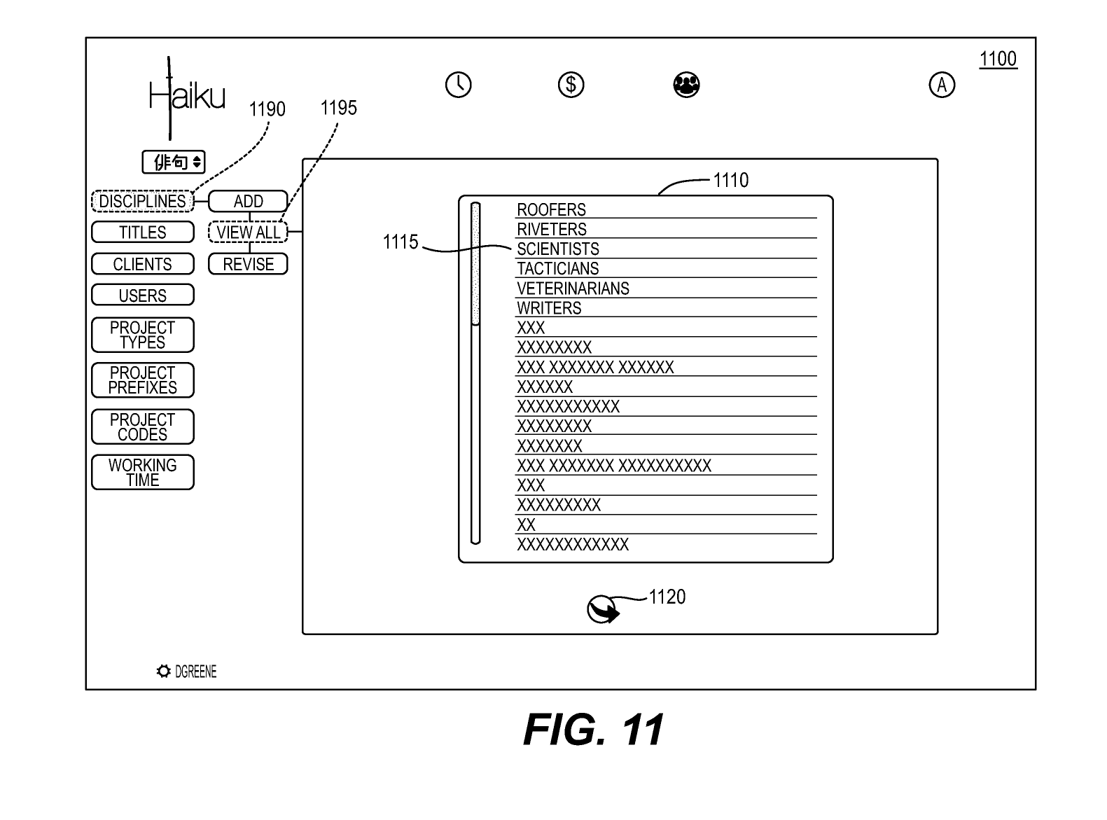

FIG. 11 is an exemplary administrative screen display for viewing existing disciplines, according to one or more embodiments of the present disclosure. The application may generate display 1100, for example, in response to user selection of View All 1195 from the secondary menu. Selection of View All 1195 may cause the application to display a list 1110 of all disciplines currently known to the application. The user may invoke View All, for example, to confirm that an added discipline has been saved to the database. If there are more viewable disciplines than display space, the application may provide a control so that the user can view the entire list. Display 1100 may further include an export control 1120, which if selected may cause the application to export the discipline list into, e.g., Microsoft Excel file as a CSV file.

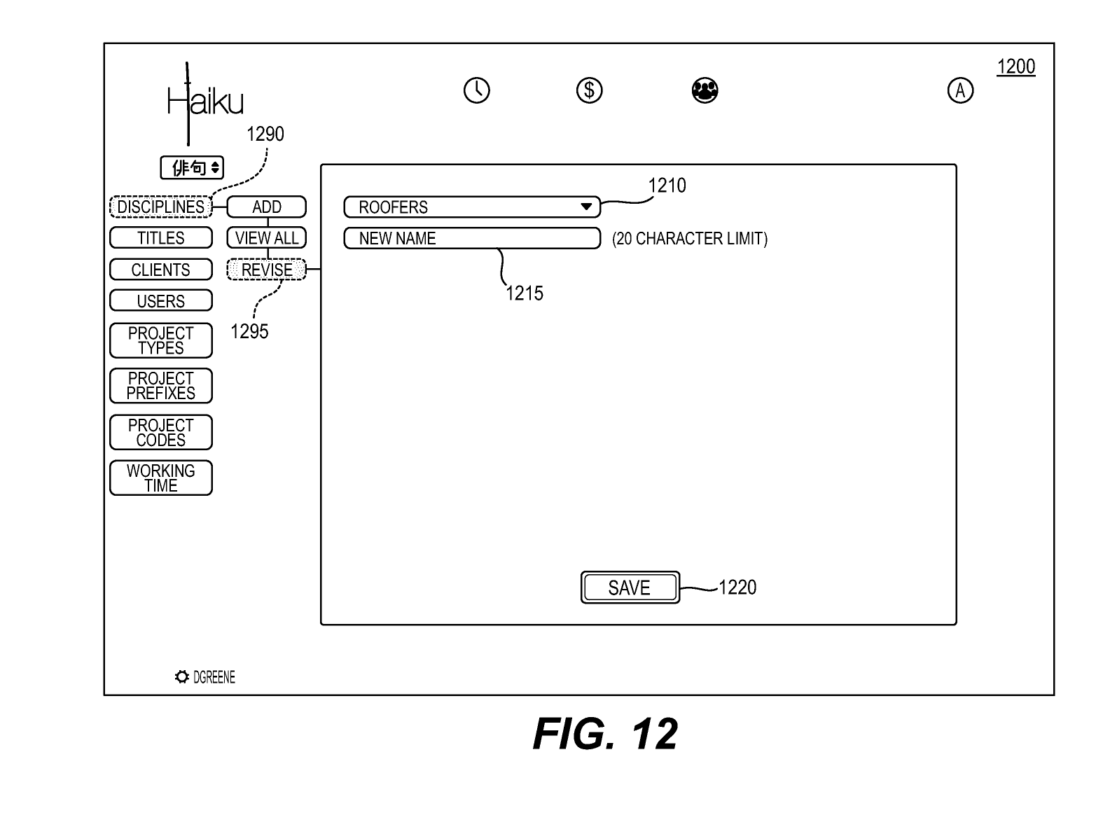

FIG. 12 is an exemplary administrative screen display for revising an existing discipline, according to one or more embodiments of the present disclosure. The application may generate display 1200, for example, in response to user selection of Revise 1295 from the secondary menu. Display 1200 may include a discipline select tool 1210, which if selected by the user may cause the application to display the list of disciplines (e.g., list 1110). Upon selection of a discipline from the list, the application may display a new name field 1215 in which the user can input text representing the discipline's new name. The application may save this entry upon user selection of the save control 1220.

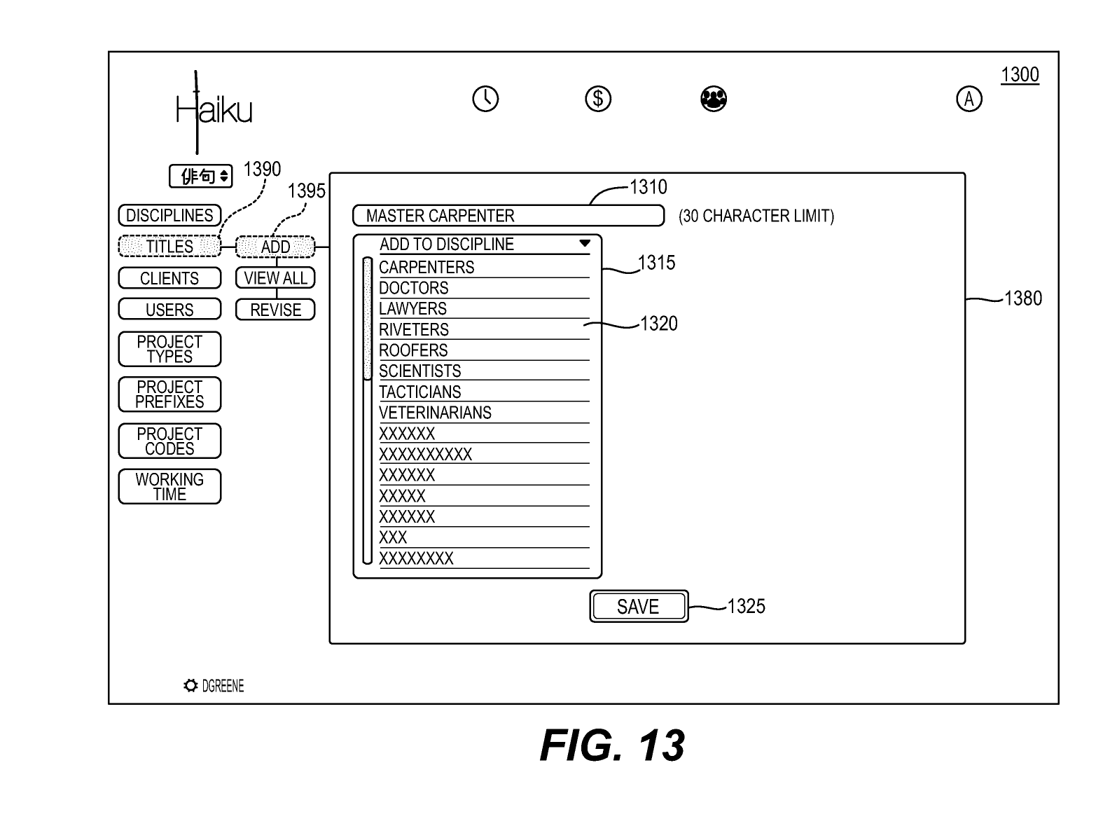

FIGS. 13-15 are exemplary administrative screen displays for adding, viewing, and revising one or more titles, according to one or more embodiments of the present disclosure. The application may render display 1300 in response to the user selection of Titles 1390 and Add 1395 icons. Display 1300 may include a working box 1380 that may further include fields such as title name field 1310. After the user selects field 1310 and enters text representing the new title, the user may further select discipline name field 1315 and choose a discipline from list 1320 with which to associate the newly added title. User selection of save control 1325 may cause the application to save the title and associate discipline. If the entered text is not valid, the application may display appropriate error message(s) upon attempt to save.

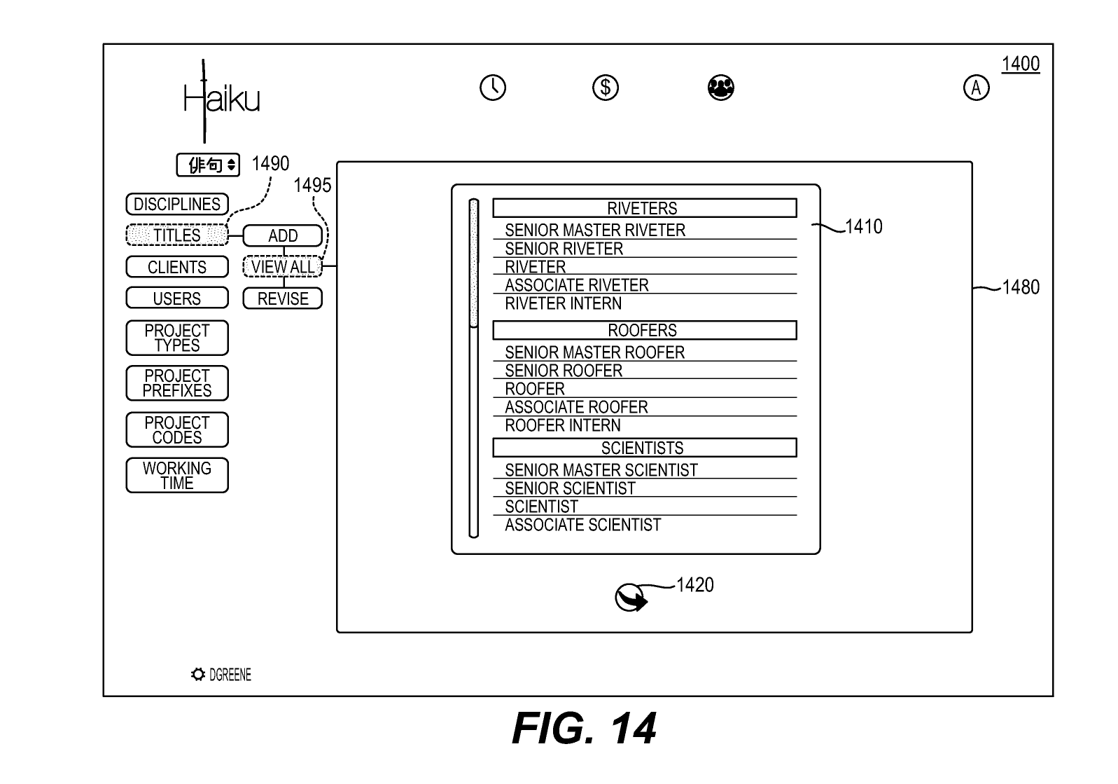

Similarly, the application may render display 1400 of FIG. 14 in response to the user selection of Titles 1490 and View All 1495 icons. Selection of View All 1495 may cause the application to display a list 1410 of all titles currently known to the application. The user may invoke View All, for example, to confirm that an added title has been saved to the database. If there are more viewable titles than display space, the application may provide a control so that the user can view the entire list. Display 1400 may further include an export control 1120, which if selected may cause the application to export the title list, e.g., into Microsoft Excel format as a CSV file.

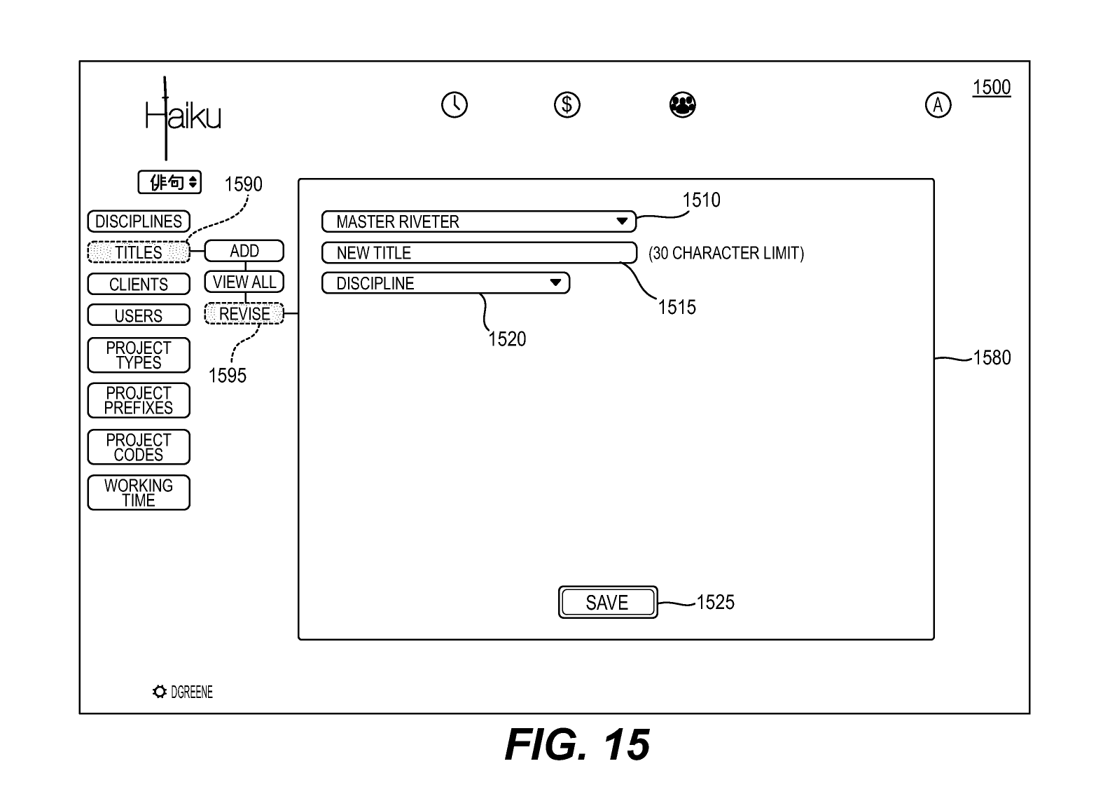

Similarly, the application may render display 1500 of FIG. 15 in response to the user selection of Titles 1590 and Revise 1595 icons. Display 1500 may include a title select tool 1510, which if selected by the user may cause the application to display the list of titles (e.g., list 1410). Upon selection of a title from the list, the application may display a new name field 1515 in which the user can input text representing the title's new name. The application may also display a discipline selection field 1520 from which the user can select a discipline to assign to the newly added title The application may save this entry upon user selection of the save control 1520.

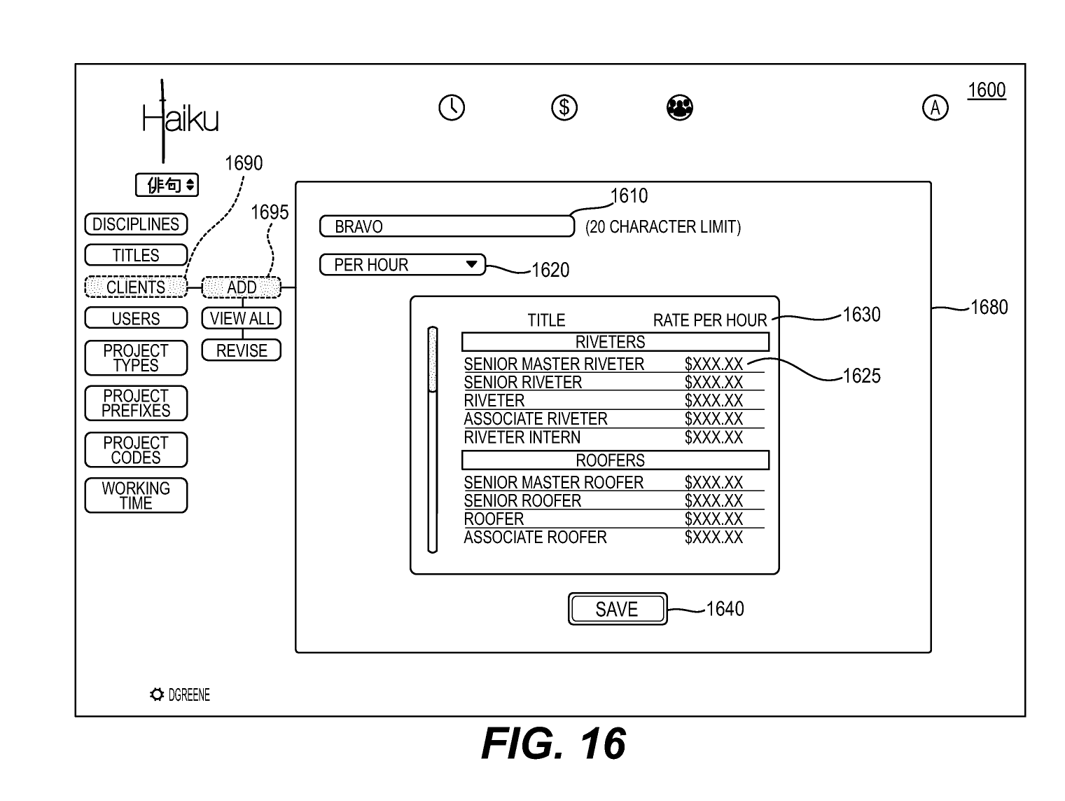

FIGS. 16-21 are exemplary administrative screen displays for adding, viewing, and revising one or more client records, according to one or more embodiments of the present disclosure. The application may render display 1600 of FIG. 16 in response to the user selection of Clients 1690 and Add 1695 icons. Display 1600 may include a working box 1680 that may further include fields such as client name 1610 and rate type 1620. After the user selects field 1610 and enters text representing the new title, the user may further select a rate type by selecting field 1620 and choosing from display options, e.g., Per Hour or Blended rate. In response to the user selecting the Per Hour option, the application displays a list 1630 of all created titles sorted alphabetically by their respective discipline assignments and by title within discipline. Each title may have an associated hourly rate (e.g., 1635), which a user may modify by selecting and entering the desired rate (e.g., in dollars). Depending on embodiment, the application may or may not require the user to enter decimal points, sub-dollar amounts, and/or dollar signs. The application may establish a maximum allowed rate, e.g., $999.99. User selection of save control 1640 may cause the application to save the entered rate. If the entered rate is not valid, the application may display appropriate error message(s) upon attempt to save.

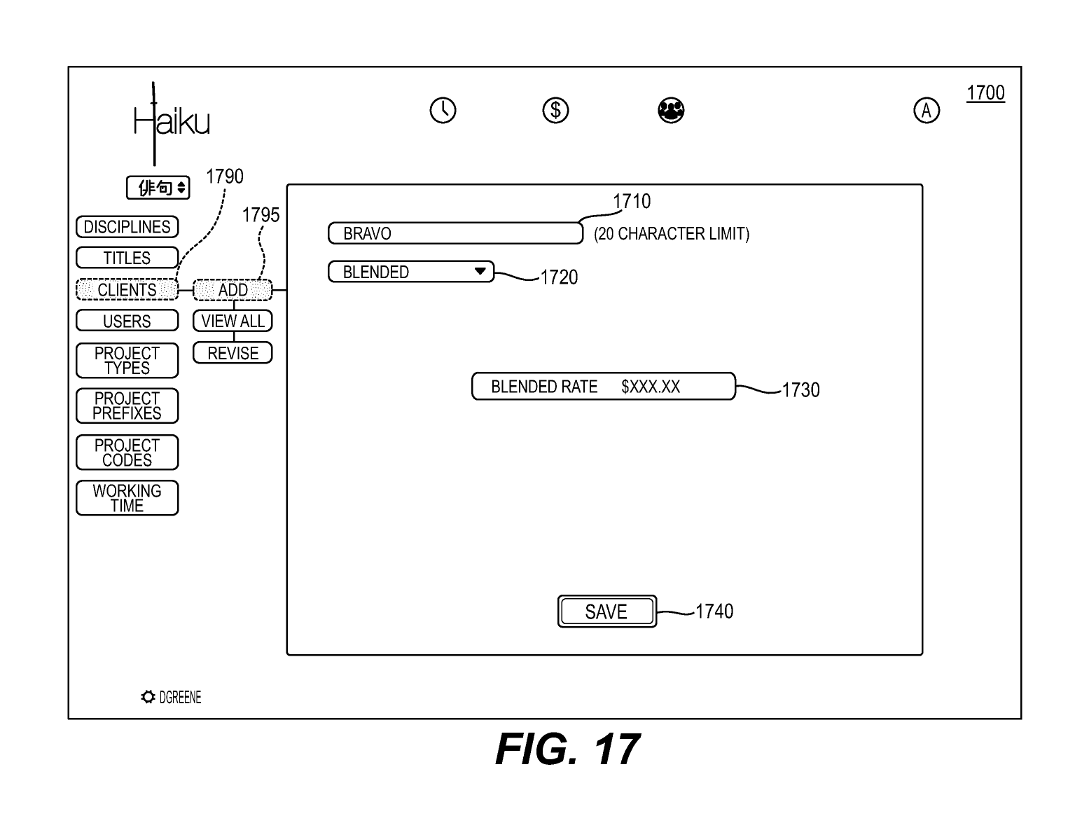

FIG. 17 shows an exemplary administrative display 1700 rendered by the application in response to the user selecting the Blended option for rate type 1620. Display 1700 includes blended rate box 1730, which the user may select to enter a Blended rate for the particular client in a similar manner as described above for the Per Hour option. In some embodiments, a Blended Rate comprises a single-dollar-per-hour value assigned to all Titles for the selected client. User selection of save control 1740 may cause the application to save the entered rate. If the entered rate is not valid, the application may display appropriate error message(s) upon attempt to save.

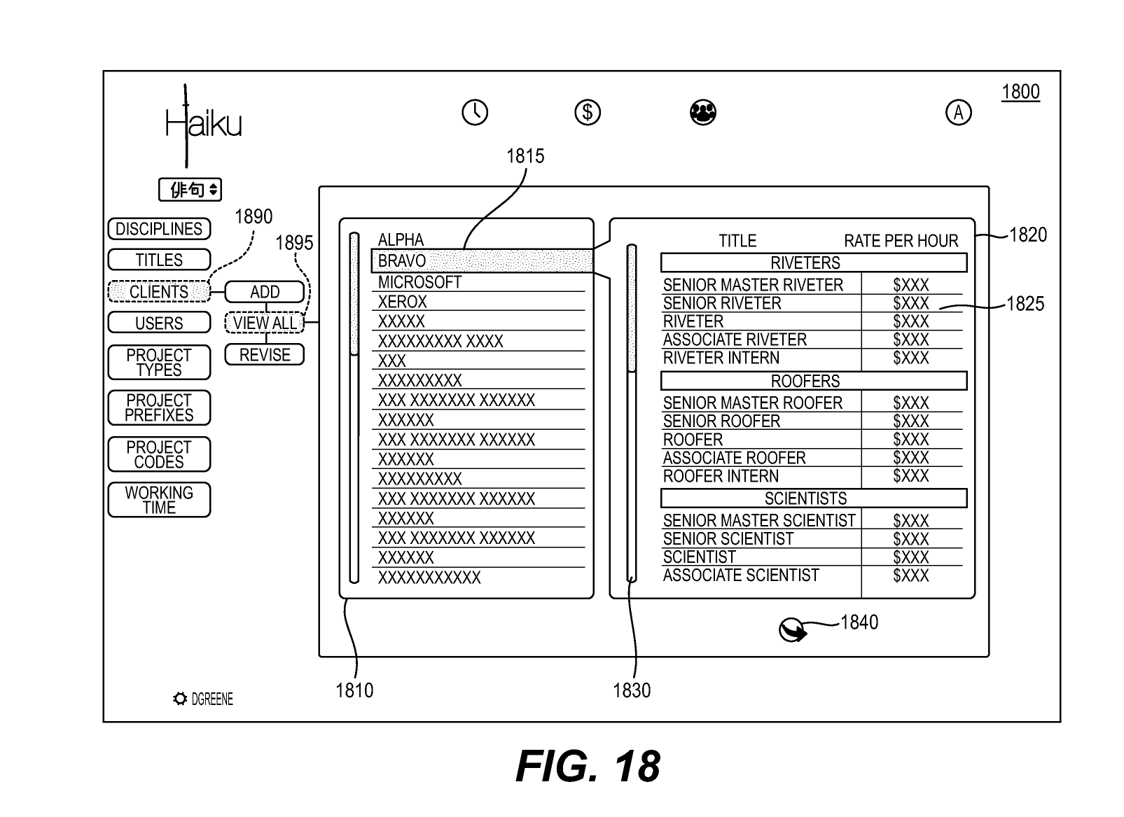

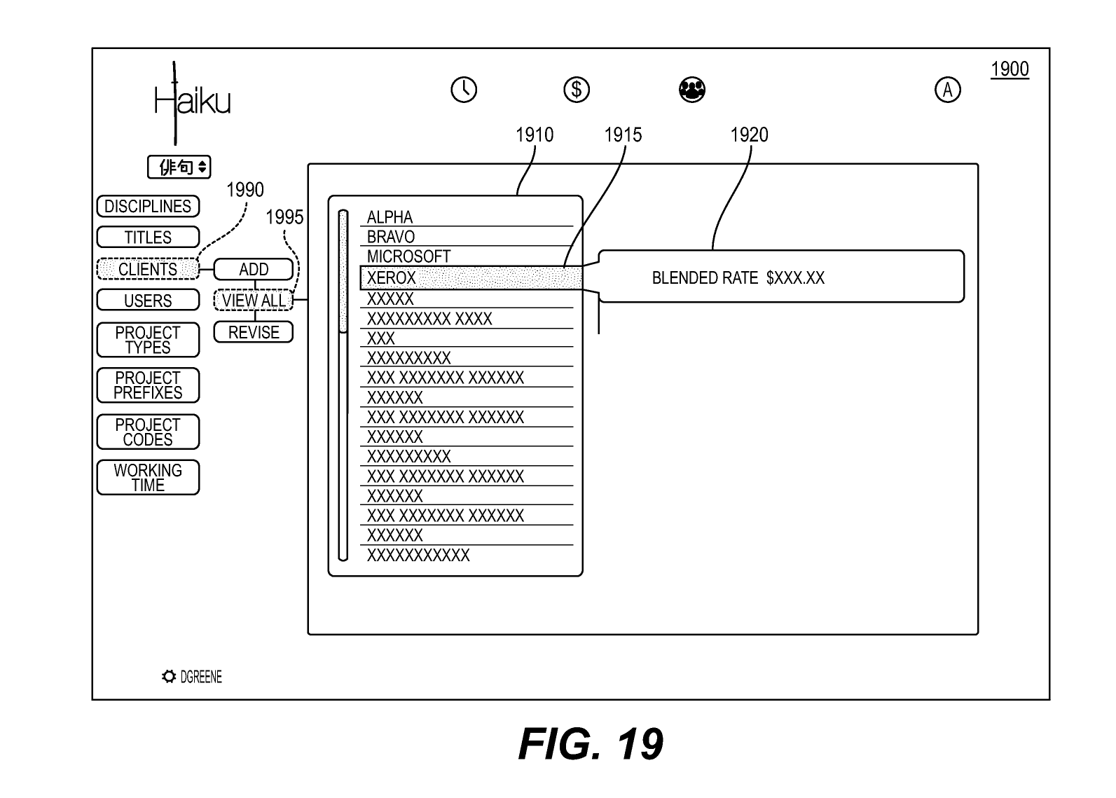

FIG. 18 shows an exemplary administrative display 1800 rendered by the application in response to the user selecting the Clients 1890 and View All 1895 icons. Display 1800 may comprise a list 1810 of all clients currently known to the application. User selection of a particular client (e.g., “Bravo” 1815) from the list may cause the application to display a list 1810 of all clients saved into the database. Upon user selection of a client (e.g., “Bravo” 1815) from the list 1810, the application displays the per-hour rates entered for the selected client, e.g., as a secondary list 1820 sorted alphabetically by discipline and title. The user may invoke View All, for example, to confirm that an added client has been saved to the database. If there are more viewable titles than display space, the application may provide a slider control 1830 so that the user can view the entire list. Display 1800 may further include an export control 1840, which if selected may cause the application to export the list 1820, e.g., into Microsoft Excel format as a CSV file. FIG. 19 shows an alternative administrative display 1900 comprising a client list 1910, whereupon user selection of a client 1915 from list 1910 may cause the application to display a blended rate 1920 corresponding to the selected client.

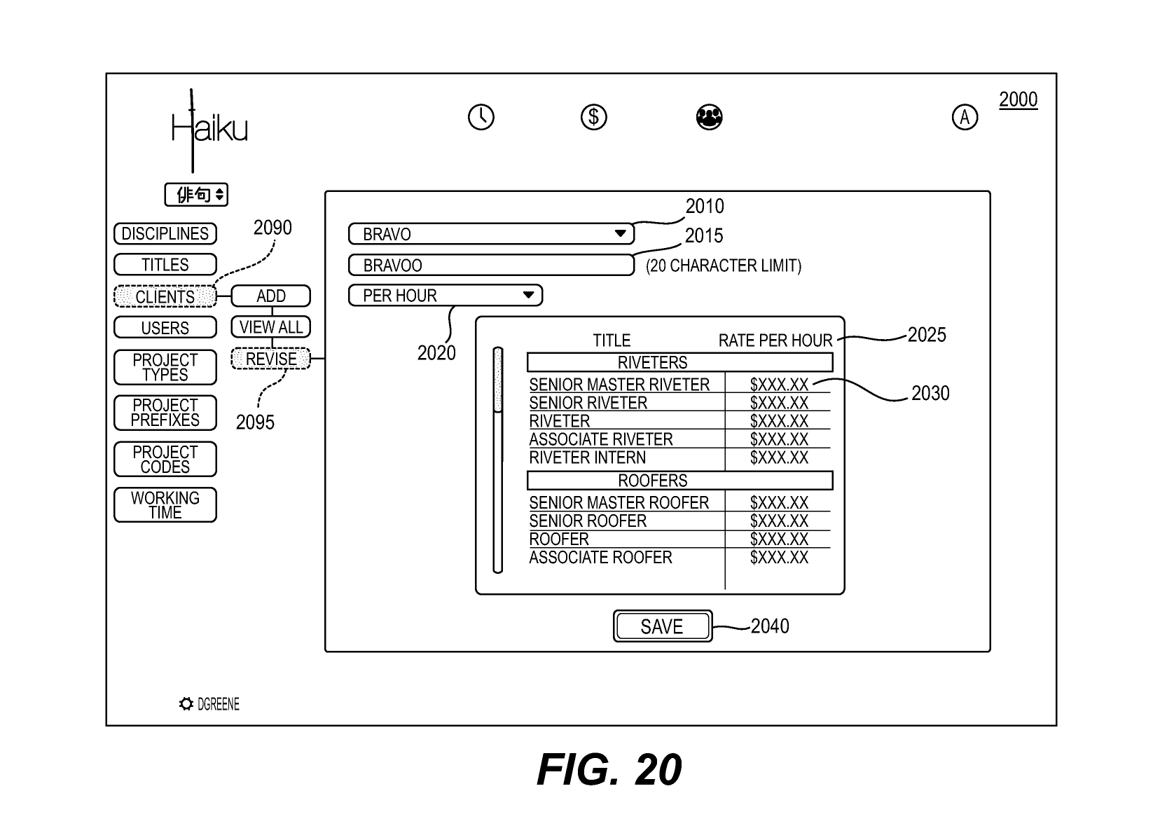

Alternately, the application may render display 2000 of FIG. 20 in response to the user selection of Clients 2090 and Revise 2095 icons. Display 2000 may include a client select tool 2010, which if selected by the user may cause the application to display the list of titles (e.g., list 1810). Upon selection of a client from the list, the application may display a new name field 2015 in which the user can input text representing the client's new name. After the user selects field 2010 and enters text representing the new client name, the user may further select a rate type by selecting field 2020 and choosing from display options, e.g., Per Hour or Blended rate. In response to the user selecting the Per Hour option, the application displays a list 2025 of all created titles sorted alphabetically by discipline assignments and by title within discipline. Each title may have an associated hourly rate (e.g., 2030), which a user may modify by selecting and entering the desired rate (e.g., in dollars). User selection of save control 2040 may cause the application to save the revised client information, e.g., name and/or rate(s). If the entered rate is not valid, the application may display appropriate error message(s) upon attempt to save.

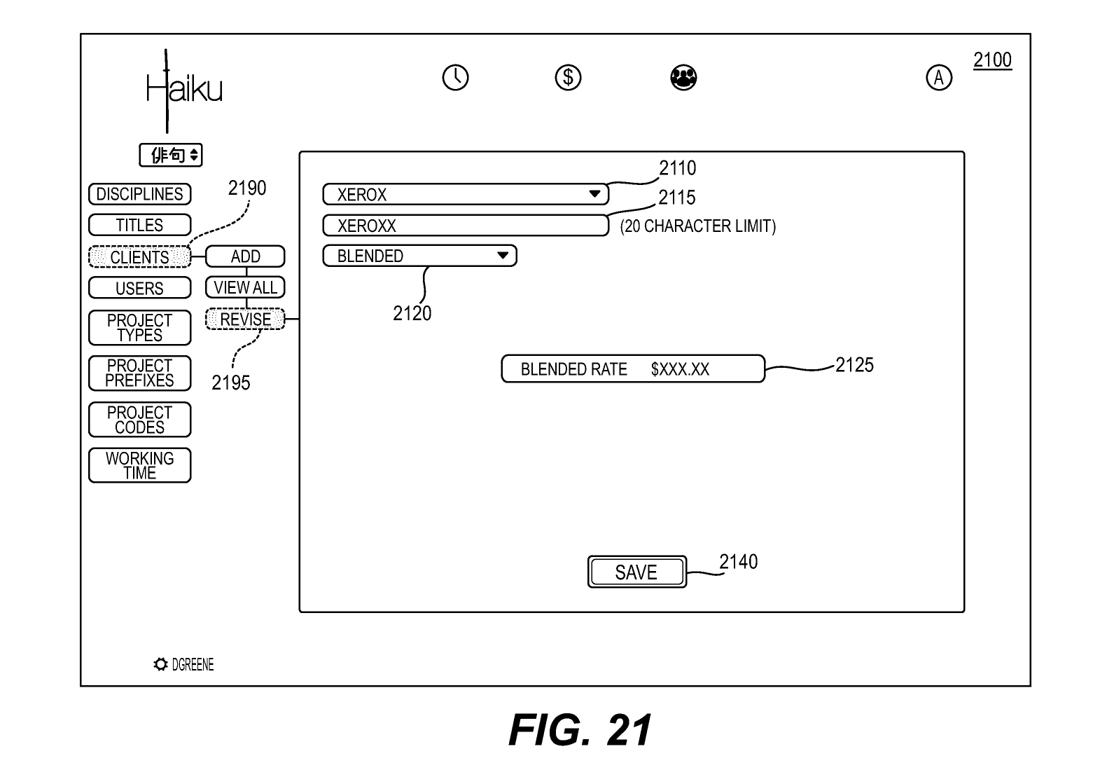

FIG. 21 shows an alternative administrative display 2100 in which the user has entered a revised name 2115 for a client and selected a blended rate using control 2120. In response, the application may display comprising a client list 1910, whereupon user selection of a client 2115 from list 2110 may cause the application to display a blended rate 2120 corresponding to the selected client, which the user may further modify and save in the manner described in more detail above.

FIGS. 22-25 are exemplary administrative screen displays for adding, viewing, and revising one or more user records, according to one or more embodiments of the present disclosure. The application may render display 2200 of FIG. 22 in response to the user selection of Users 2290 and Add 2295 icons. Display 2200 may include a working box 2280 that may further include fields such as user name 2210, user discipline 2215, and user title 2220. The user may enter the name of a new user in field 2210, select a discipline from field 2215, and further select a title from field 2220. Working box 2280 may also comprise a start date field 2225 and icon 2226, as well as end date field 2230 and icon 2231. The user may enter a start (end) date for the worker textually in field 2225 (2230) or by selecting icon 2226 (2231), which may cause the application to display a calendar field from which the user may further select a start (end) date.

Working box 2280 in display 2200 may further comprise controls for various administrative settings for the user. For example, display 2200 comprises View Time Interface control 2235, Time Interface Admin control 2240, View Money Interface control 2245, View People Interface control 2250, and People Interface Admin control 2255. Each of these controls comprises four parts, labeled respectively a through d (e.g., 2235a-d). Part a of each control provides a text field describing the control. Parts b and c are user-selectable fields that enable (“Y”) and disable (“N”) the selected user's permission for the particular interface. Only one of parts b and c may be selected for each control, e.g., they are mutually exclusive. Part d of each control comprises a field which, if selected by a user, shows a drop-down list of values relevant to the particular control from which a particular value may be selected. Part d may be inaccessible (e.g., ghosted out) unless corresponding part b has been selected. Display 2200 may further comprise a System Admin control 2260 with parts a through c described above, and a questions control 2265, which if selected by the user may cause the application to display additional information concerning the format and/or content of the controls 2235-2255, e.g., in a light box format.

The particular controls 2235-2260 are described as follows. View Time Interface control 2235 controls the selected user's permission to view data displayed on the Time Interface. If the user permission is enabled, e.g., by selecting 2235b, the amount of data viewable may be selectable via a list of clients according to control 2235d. Time Interface Admin control 2240 controls the selected user's permission to write or update data displayed in the Time Interface. If the user permission is enabled, e.g., by selecting 2240b, the amount of data writable or editable may be selectable via a list of clients according to control 2240d. View Money Interface control 2245 controls the selected user's permission to view data displayed on the Money Interface. If the user permission is enabled, e.g., by selecting 2245b, the amount of data viewable may be selectable via a list of clients according to control 2245d. View People Interface control 2250 controls the selected user's permission to view data displayed on the People Interface. If the user permission is enabled, e.g., by selecting 2250b, the amount of data viewable may be selectable via a list of disciplines according to control 2250d. People Interface Admin control 2255 controls the selected user's permission to write or update data displayed in the People (or Resources) Interface. If the user permission is enabled, e.g., by selecting 2255b, the amount of data writable or editable may be selectable via a list of disciplines according to control 2255d. System Admin control 2260 controls the selected user's permission to view, write, and update data in all displays of the Administrative Interface.

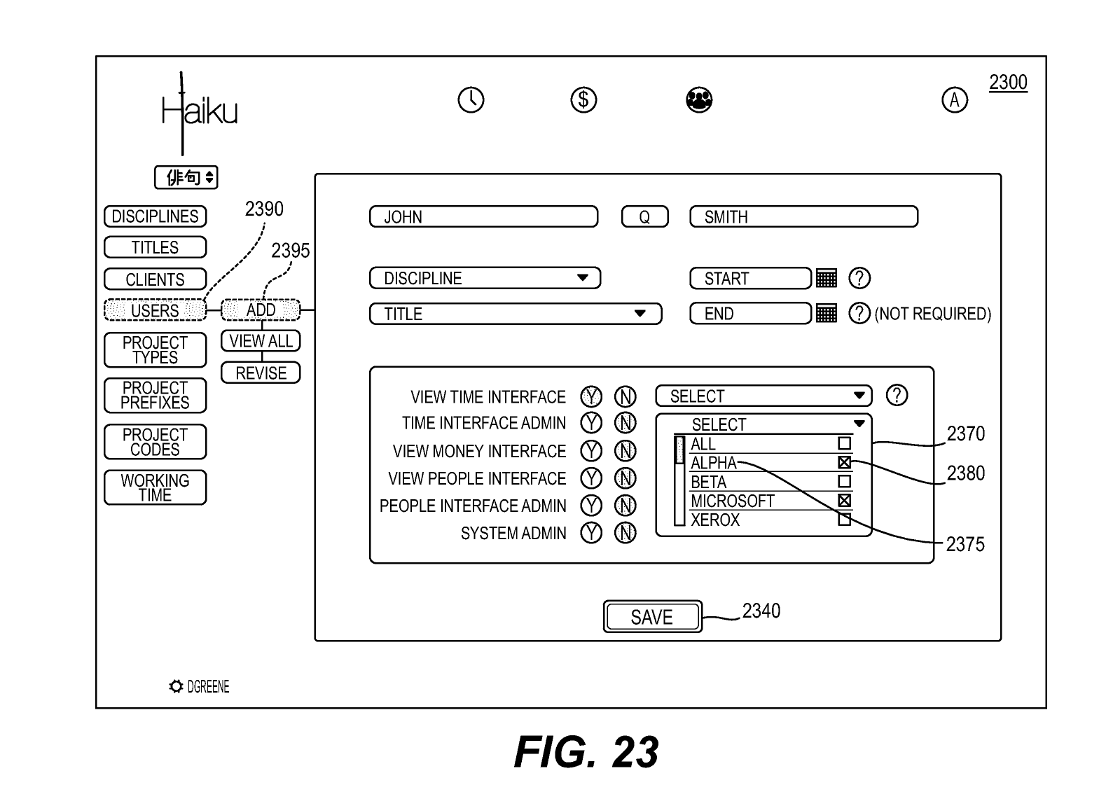

FIG. 23 shows an exemplary administrative display 2300 provided by the application in response to selection of Time Interface control 2240b (“Y”) and selection of control 2240d. Exemplary display 2300 includes a drop-down list 2370 of clients from which one or more entries may be selected to enable permission for the selected user to view the Time Interface for those particular clients. Client entries (e.g., “Alpha” 2375) may be selected by ticking the corresponding box (e.g., 2380). In some embodiments, controls 2235d, 2245d, 2250d, and 2255d may operate in a substantially similar manner as control 2240d described above.

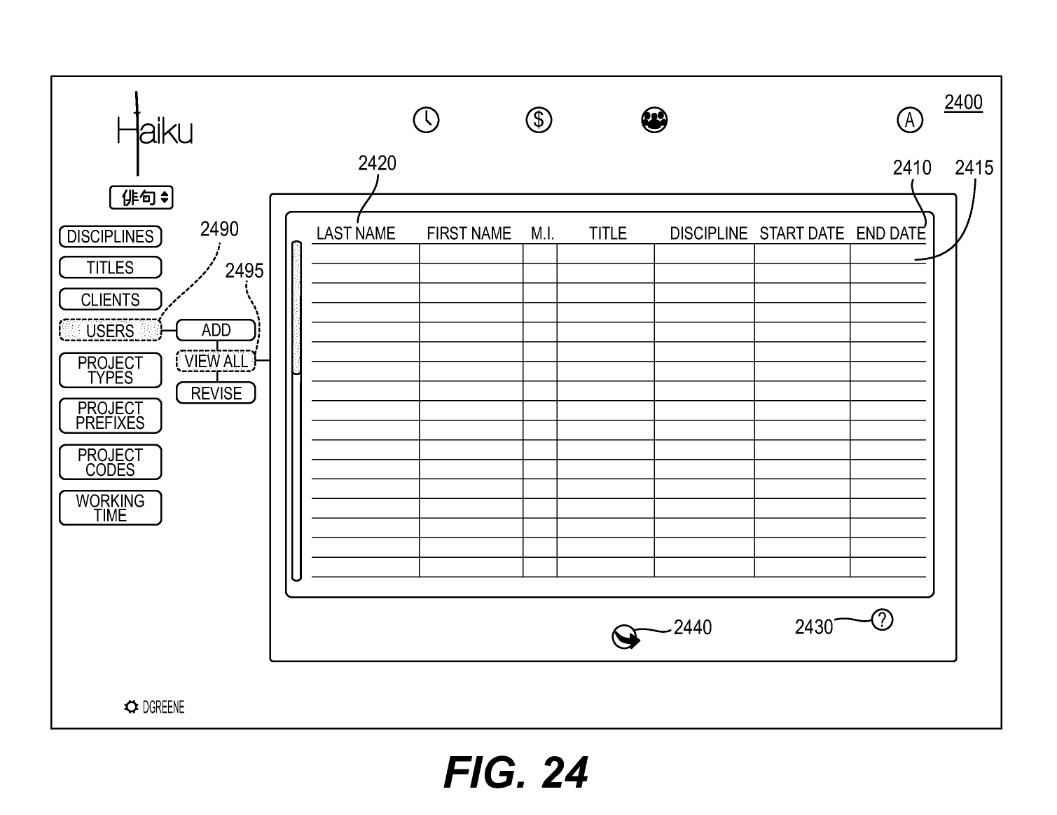

FIG. 24 shows an exemplary administrative display 2400 rendered by the application in response to the user selecting the Users 2490 and View All 2495 icons. Display 2300 may comprise a list 2410 of all users currently known to the application. List 2410 may comprise various exemplary fields for each user, such as name, title, discipline, start date, end date, etc. Display 2400 may further comprise a questions control 2430, which if selected by the user may cause the application to display additional information concerning the format and/or content of list 2410, e.g., in a light box format. Display 2400 may further include an export control 2440, which if selected may cause the application to export the list 2410, e.g., into Microsoft Excel format as a CSV file.

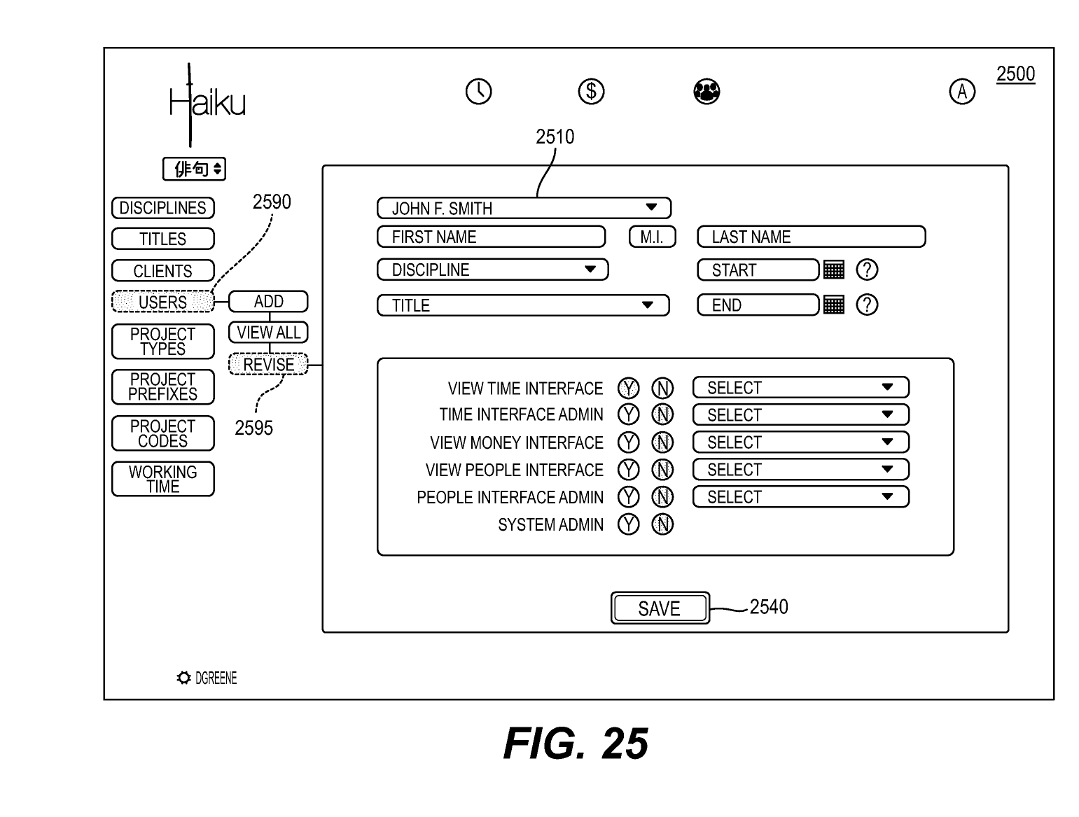

FIG. 25 shows an exemplary administrative display 2500 rendered by the application in response to the user selecting the Users 2590 and Revise 2595 icons. Display 2500 may include a user select tool 2510, selection of which may cause the application to display the list of users (e.g., list 2410). Selection of a user from the list may cause the application to display the various fields shown in and described above with reference to FIGS. 22 and 23, with which the user may revise previously entered information or add new information pertaining to the selected user. Invocation of save control 2540 may cause the application to save the revised user information. If the entered user is not valid, the application may display appropriate error message(s) upon attempt to save.

FIGS. 26-28 are exemplary administrative screen displays for adding, viewing, and revising one or more project types, according to one or more embodiments of the present disclosure. The application may render display 2600 of FIG. 26 in response to the user selection of Project Types 2690 and Add 2695 icons. Display 2600 may include a working box 2680 that may further include fields such as project name 2610, into which the user may enter the desired project name. Display 2600 may further comprise a project icon field 2620, from which the user may select one of the displayed icons (e.g., 2622) to represent the project type to be added. If there are more selectable icons than display space in field 2620, the application may provide a slider control 2624 so that the user can view the entire list. The currently selected project icon may be displayed, e.g., in field 2615. Display 2600 may further comprise questions controls 2611 and 2626, which if selected by the user may cause the application to display additional information concerning the format and/or content of project name field 2610 and project icon field 2620, e.g., in a light box format.

Display 2600 may further comprise an LOE entry field 2630 that shows the number of hours required (e.g., hours 2636) for each title (e.g., Senior Master Riveter 2634) in the selected project type. Titles are sorted alphabetically by Discipline type and then Title. Any Title with assigned Discipline Type that has been created previously will be displayed in field 2630. In response to selection of a particular title from the list in field 2630, the application may prompt the user to enter the number of hours required for the selected title to complete the selected type of project. Prior to user entry, the field 2630 may be populated with default number of hours, e.g., per company or client guidelines for the project type, client, etc. In some embodiments, hours for a particular title may be blank prior to entry of hours by a user.

Display 2600 may further comprise a graphic equalizer control 2640 that enables the user to set the Base LOE across the project duration for the Project Type. The assignment of LOE across project duration may be done per each 10% portion of total project duration. Weight is assigned in increments of 10% of total hours assigned (e.g., hours assigned by entry into field 2630). Each portion of the duration is associated with a particular slider bar, e.g., slider bar 2642, which may be repositioned by, e.g., click, hold, and drag operation, thereby changing the portion of total hours assigned to the corresponding portion of the project duration. Any 10% portion of the project duration can contain as little as 0% and as much as 100% of the total hours assigned. A total assigned percentage field 2648 also may be displayed and is updated by the application in response to user repositioning of the respective sliders. Each 10% portion may be represented by a color-coded element, e.g., element 2644. If repositioning of a slider (e.g., 2642) increments the total hours above 100%, the application may change the color of the displayed elements (e.g., to red) and the total assigned percentage 2648 to indicate the exceeded limit.

Graphic Equalizer control 2640 may be non-operational (e.g., ghosted out) unless valid number of hours for at least one title is present in 2630, at which point it will become operational. LOE entry field 2630 may further comprise an All control 2638, which if activated may cause the application to update the hourly distribution per project duration according to the current settings visible in graphic equalizer control 2640. If the All control 2638 is not selected, the graphic equality control 2640 settings apply only to the currently selected title. Invocation of save control 2650 may cause the application to save the added project type information. If the entered project type information is not valid, the application may display appropriate error message(s) upon attempt to save.

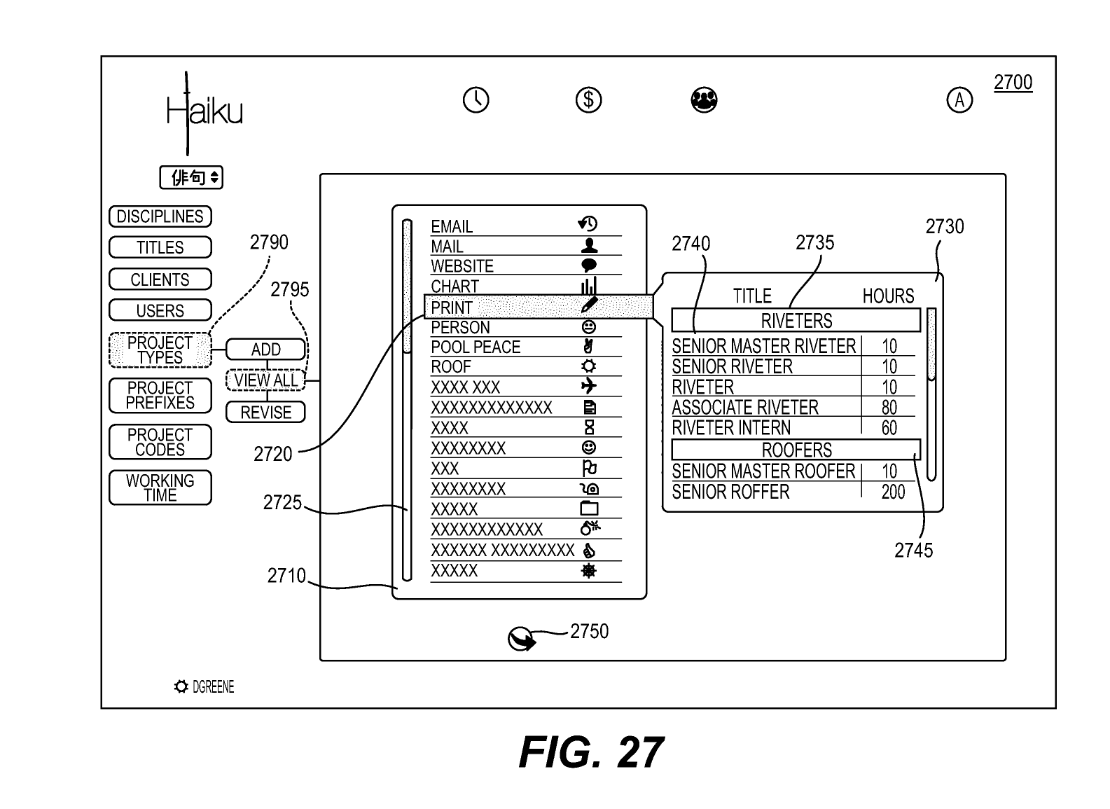

FIG. 27 shows an exemplary administrative display 2700 rendered by the application in response to the user selecting the Project Types 2790 and View All 2795 icons. The user may invoke View All, for example, to confirm that an added project type has been saved to the database. Display 2700 may comprise a list 2710 of all project types currently known to the application along with their corresponding icons. Selection of a particular project type (e.g., “Print” 2720) from the list may cause the application to display the number of hours for each title corresponding to the selected project type, e.g., as a secondary list 2730 sorted alphabetically by discipline (e.g., Riveters 2735) and title (e.g., Senior Master Riveter 2740). If there are more viewable project types and/or titles than display space in fields 2710 and 2730, respectively, the application may provide one or more slider controls 2725, 2745 so that the user can view the entire list(s) of items. Display 2700 may further include an export control 2750, which if selected may cause the application to export the list 2730, e.g., into Microsoft Excel format as a CSV file.

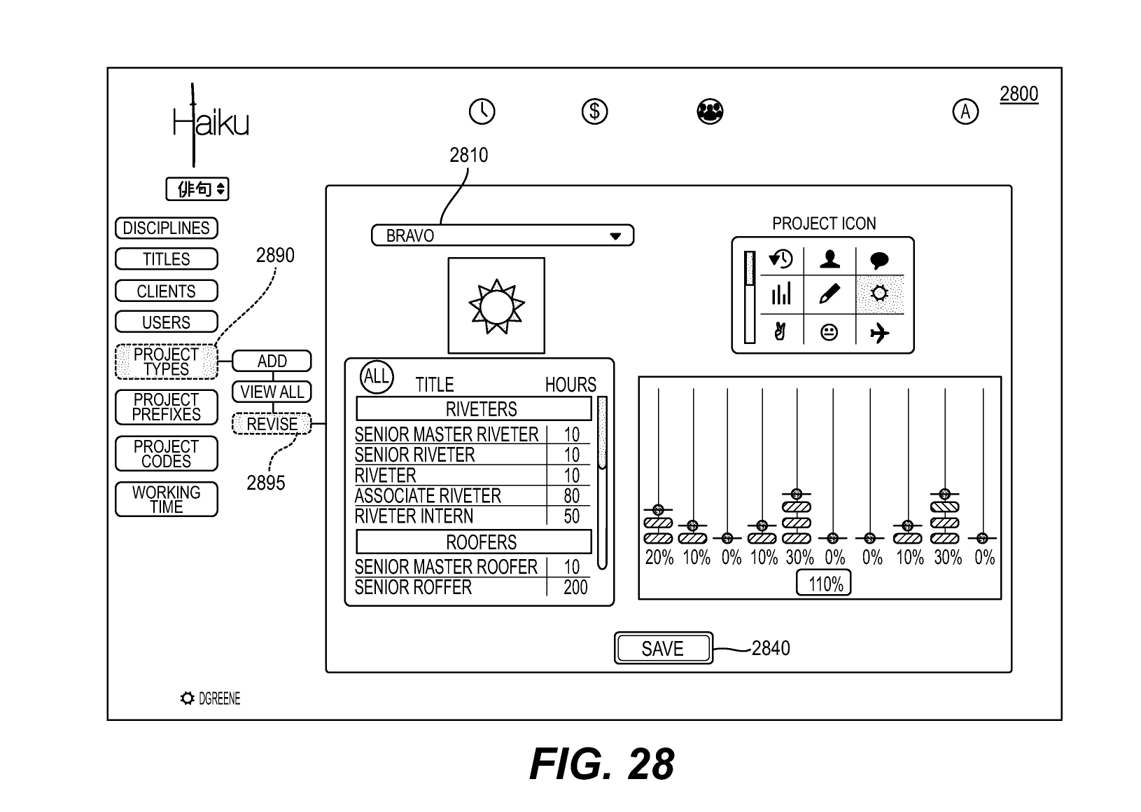

FIG. 28 shows an exemplary administrative display 2800 rendered by the application in response to the user selecting the Project Types 2890 and Revise 2895 icons. Display 2800 may include a project type select tool 2810, selection of which may cause the application to display the list of project types previously entered into the database. Selection of a project type from the list may cause the application to display the various fields shown in and described above with reference to FIG. 26, with which the user may revise previously entered information or add new information pertaining to the selected project type. Invocation of save control 2840 may cause the application to save the revised project type information. If the entered project type information is not valid, the application may display appropriate error message(s) upon attempt to save.

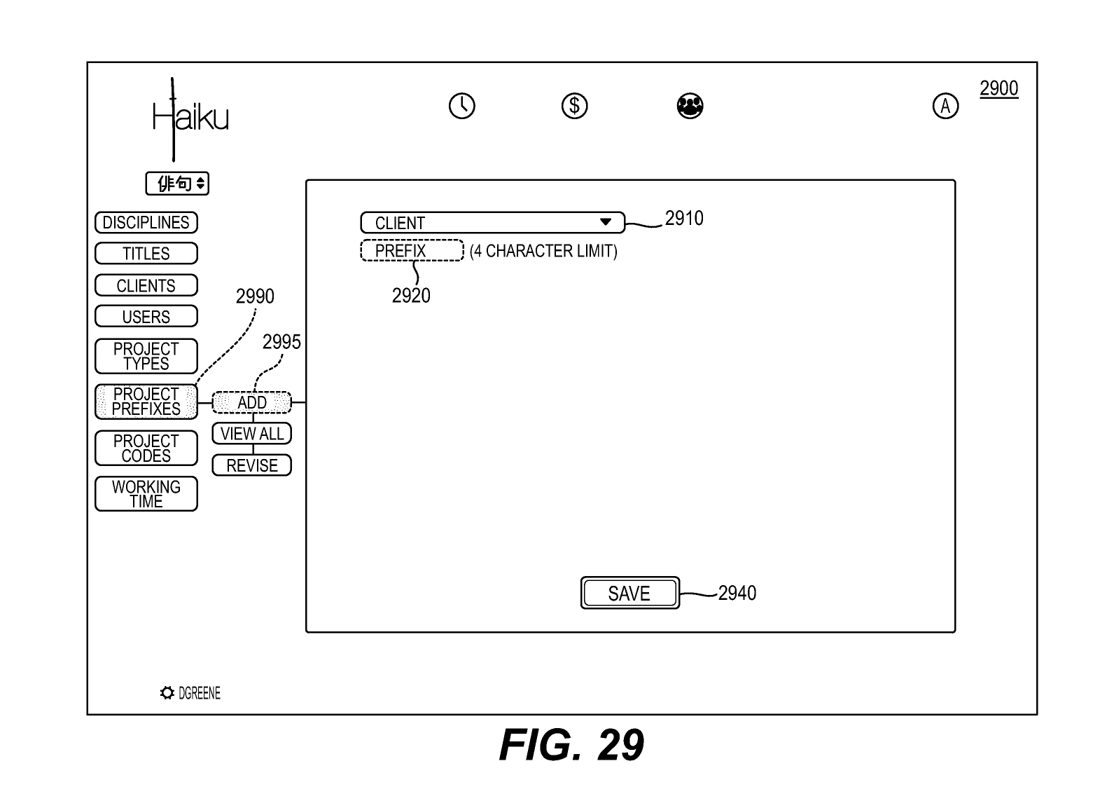

FIGS. 29-31 are exemplary administrative screen displays for adding, viewing, and revising one or more project prefixes for a particular client, according to one or more embodiments of the present disclosure. The application may render display 2900 of FIG. 29 in response to the user selection of Project Prefixes 2990 and Add 2995 icons. Display 2900 may include a working box 2980 that may further include fields such as client selection tool 2910, which if selected may cause the application to display a list of clients. In response to selection of a particular client, the application may display a prefix entry field 2920 into which a user may enter a new prefix associated with the selected client. Invocation of save control 2940 may cause the application to save the revised project prefix information. If the entered project prefix information is not valid (e.g., includes non-alphanumeric characters or too many characters), the application may display appropriate error message(s) upon attempt to save.

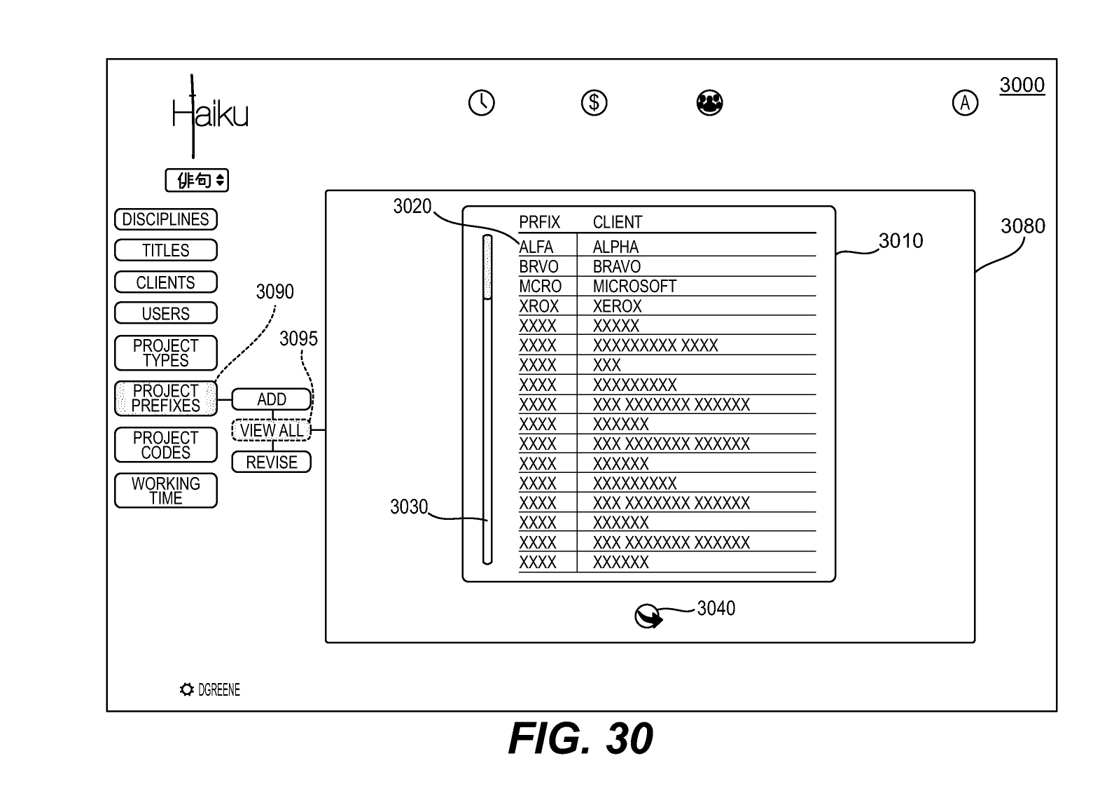

FIG. 30 shows an exemplary administrative display 3000 rendered by the application in response to the user selecting the Project Prefixes 3090 and View All 3095 icons. The user may invoke View All, for example, to confirm that an added project prefix for a particular client has been saved to the database. Display 3000 may include a working box 3080 that may further comprise a list 3010 of all clients currently known to the application. Selection of a particular client (e.g., “Alpha” 3020) from the list may cause the application to display the project prefixes associated with the selected client e.g., as a secondary list sorted alphabetically by prefix. If there are more viewable clients and/or project prefixes titles than display space in working box 3080, the application may provide one or more slider controls (e.g., control 3030) so that the user can view the entire list(s) of items. Display 3000 may further include an export control 3040, which if selected may cause the application to export the list of project prefixes for the selected client, e.g., into Microsoft Excel format as a CSV file.

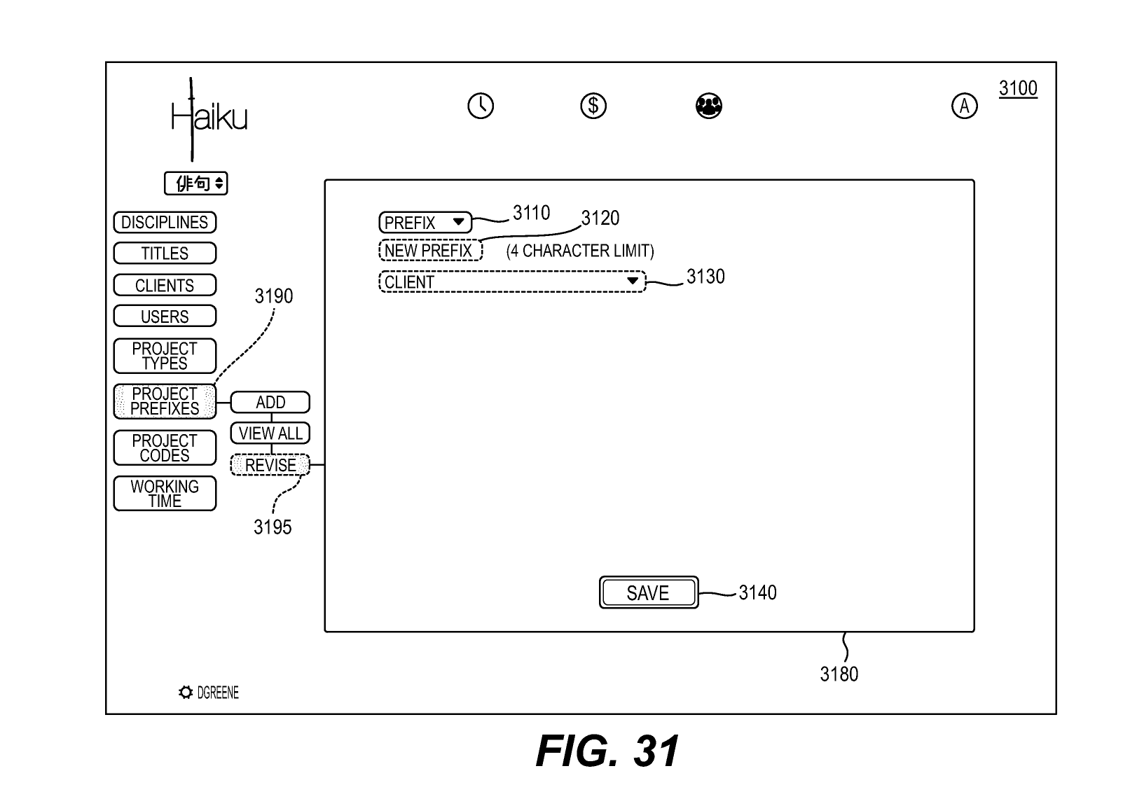

FIG. 31 shows an exemplary administrative display 3100 rendered by the application in response to the user selecting the Project Prefixes 3190 and Revise 3195 icons. Display 3100 may include a working box 3180 that may further comprise a project prefix select tool 3110, selection of which may cause the application to display the list of project prefixes previously entered into the database. Selection of a project prefix from the list may cause the application to display the selected prefix in field 3120, which the user may revise accordingly, and a client selection tool 3130, from which a client to be associated with the revised prefix in field 3120. Invocation of save control 3140 may cause the application to save the revised project prefix information and any revised client association. If the entered project type information is not valid, the application may display appropriate error message(s) upon attempt to save.

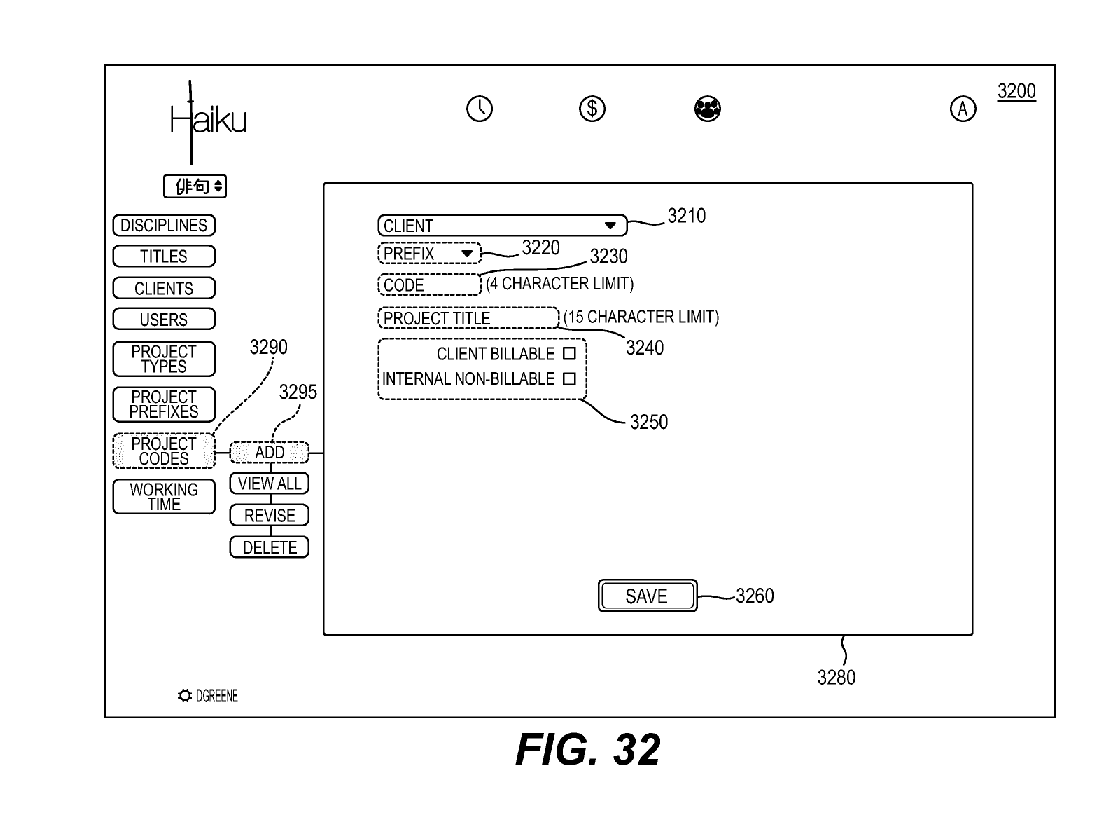

FIGS. 32-34 are exemplary administrative screen displays for adding, viewing, and revising one or more project codes and/or names for a particular client, according to one or more embodiments of the present disclosure. The application may render display 3200 of FIG. 32 in response to the user selection of Project Codes 3290 and Add 3295 icons. Display 3200 may include a working box 3280 that may further include fields such as client selection tool 3210, which if selected may cause the application to display a list of clients. In response to selection of a particular client, the application may display a prefix select field 3220, which if selected may cause the application to display a list of project prefixes associated with the selected client. In response to selection of a particular project prefix, the application may display a project code field 3230 and project title field 3240, into which the user may enter values for the project code and project title, respectively. Display 3200 may further comprise a project billable selection tool 3250, by which the user may select whether the project code is billable or non-billable to the selected client, e.g., by choosing the appropriate tick box. Invocation of save control 3260 may cause the application to save the revised project code, title, and/or billable information. If the entered project information is not valid (e.g., includes non-alphanumeric characters or too many characters), the application may display appropriate error message(s) upon attempt to save.

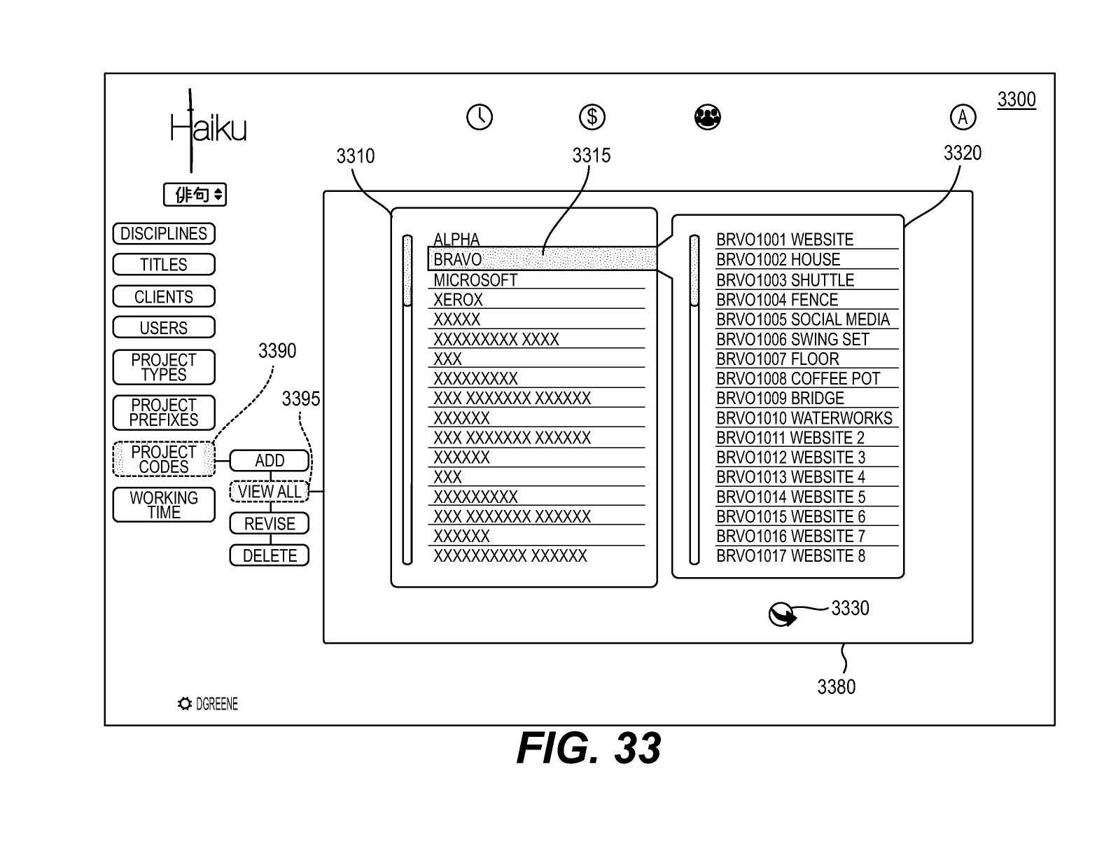

FIG. 33 shows an exemplary administrative display 3300 rendered by the application in response to the user selecting the Project Codes 3390 and View All 3395 icons. The user may invoke View All, for example, to confirm that an added project code for a particular client has been saved to the database. Display 3300 may include a working box 3380 that may further comprise a list 3310 of all clients currently known to the application. Selection of a particular client (e.g., “Bravo” 3315) from the list may cause the application to display the project codes and descriptions associated with the selected client, e.g., as a secondary list sorted alphabetically by project code. If there are more viewable clients and/or project codes than display space in working box 3380, the application may provide one or more slider controls so that the user may view the entire list(s) of items. Display 3300 may further include an export control 3330, which if selected may cause the application to export the list of project codes for the selected client, e.g., into Microsoft Excel format as a CSV file.

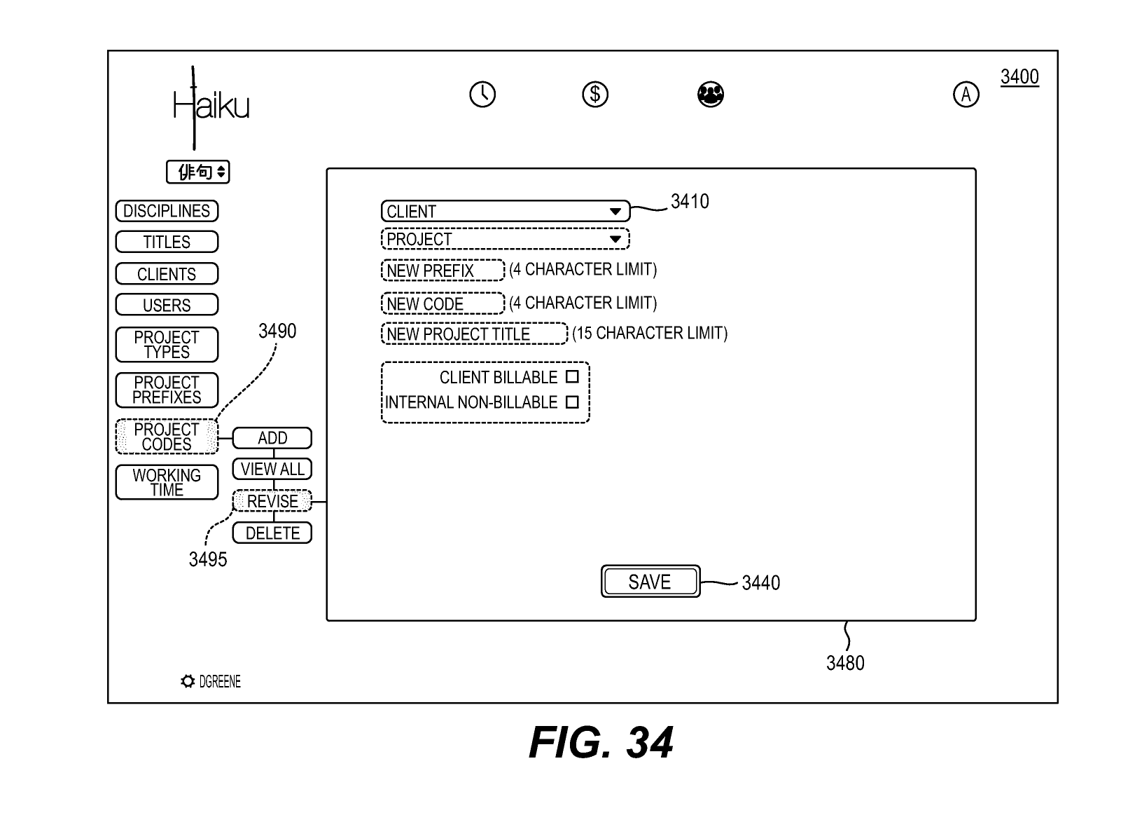

FIG. 34 shows an exemplary administrative display 3400 rendered by the application in response to the user selecting the Project Codes 3490 and Revise 3495 icons. Display 3400 may include a working box 3480 that may further comprise a client select tool 3110, selection of which may cause the application to display the list of clients previously entered into the database. Selection of a client from the list may cause the application to display a project code select tool 3420, selection of which may cause the application to display the list of projects codes previously entered into the database in association with the selected client. Selection of a project code from the list may cause the application to display various fields, such as those described above with reference to FIG. 32, into which the user may enter revised project prefix, code, title, and/or billable information. Invocation of save control 3440 may cause the application to save the revised project information in association with the selected client in the database. If the entered project information is not valid (e.g., includes non-alphanumeric characters or too many characters), the application may display appropriate error message(s) upon attempt to save.

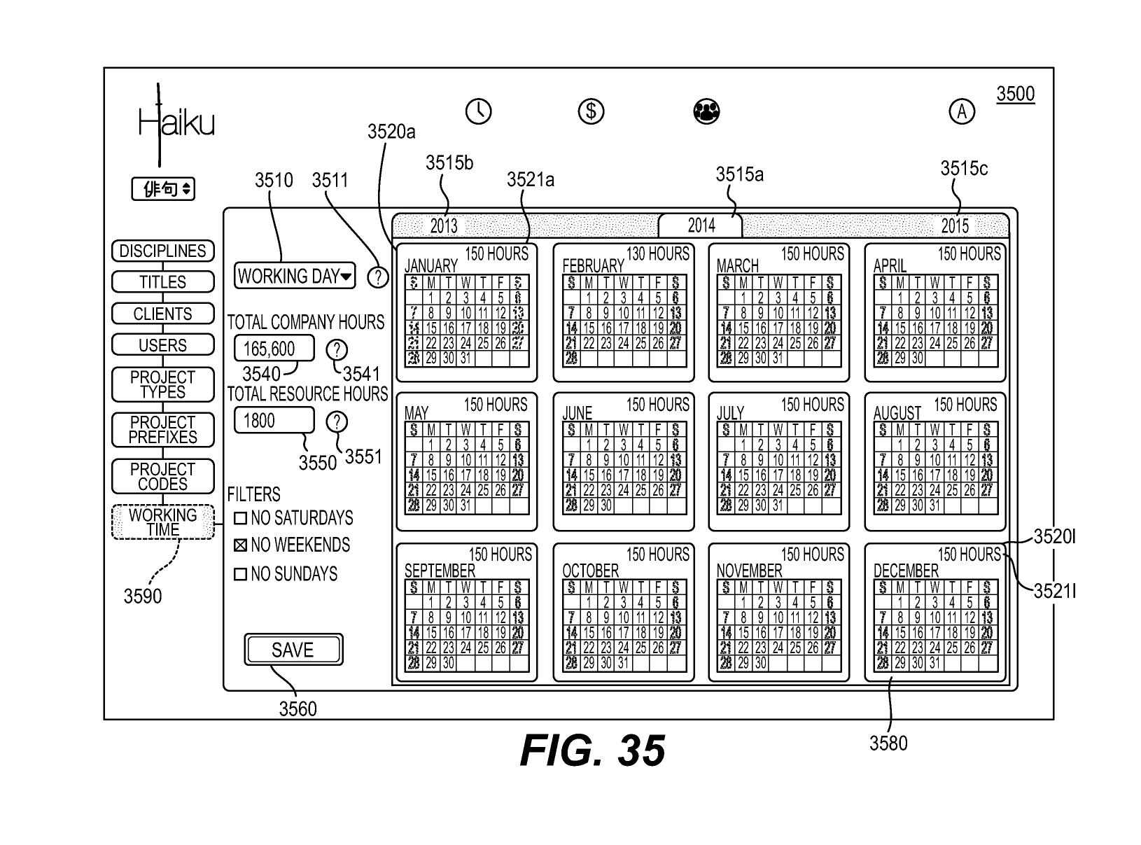

FIG. 35 shows an exemplary administrative display 3500 rendered by the application in response to the user selecting the Working Time 3590 icon. Display 3500 may include a working box 3580 that may further comprise working day select tool 3510, selection of which may cause the application to display a list of working day options from which the user can select the length of the working day (e.g., 7.5 hours). Display 3500 may also include a calendar field, which may be rendered in a manner similar to calendar boxes 410 and 990 described above with reference to FIGS. 4 and 9. The calendar field may include various date-related fields including year fields 3515a-c and month fields 3520a through 3520l. Selection of a year field (e.g., 3515a) may cause the application to display the month fields corresponding to the selected year. Each month field (e.g. “January” 3520a) comprises the appropriate number of days arranged, e.g., in a weekly format, with working and non-working days distinguished by color. A user may change a Working Time day into a Non-Working Time day by selecting the corresponding area in the month field, as described above. In some embodiments, the initial or default setting for all days in a year can be Working Time, from which a user can remove particular Non-Working Days according to preference and/or requirements. In some embodiments, the application can provide additional controls in display 3500 for this purpose, e.g., “No Weekends”, “No Saturdays”, “No Sundays”, “No Government Holidays,” etc. In some embodiments, the application can provide a control for selecting whether the Working/Non-Working Day selection is for a resource, a title, a discipline, or the company as a whole. Each month field 3520a-1 is associated with a monthly working time field 3521a-1; these fields will be updated according to changes to Working and Non-Working days in the respective months, as well as to hours-per-day selections made using tool 3510.

In addition, changes to Working/Non-Working Days and hours-per-day may cause the application to update the value displayed in the total resource hours field 3550, which is the sum of the monthly working times displayed, and the value displayed in the total company hours field 3540, which represents the product of the value in field 3550 and the number of resources in the company. Invocation of save control 3560 may cause the application to save the revised working time information in the database. Display 2600 may further comprise questions controls 3541 and 3551, which if selected by the user may cause the application to display additional information concerning the format and/or content of total company hours field 3540 and total resource hours field 3550, respectively, e.g., in a light box format.

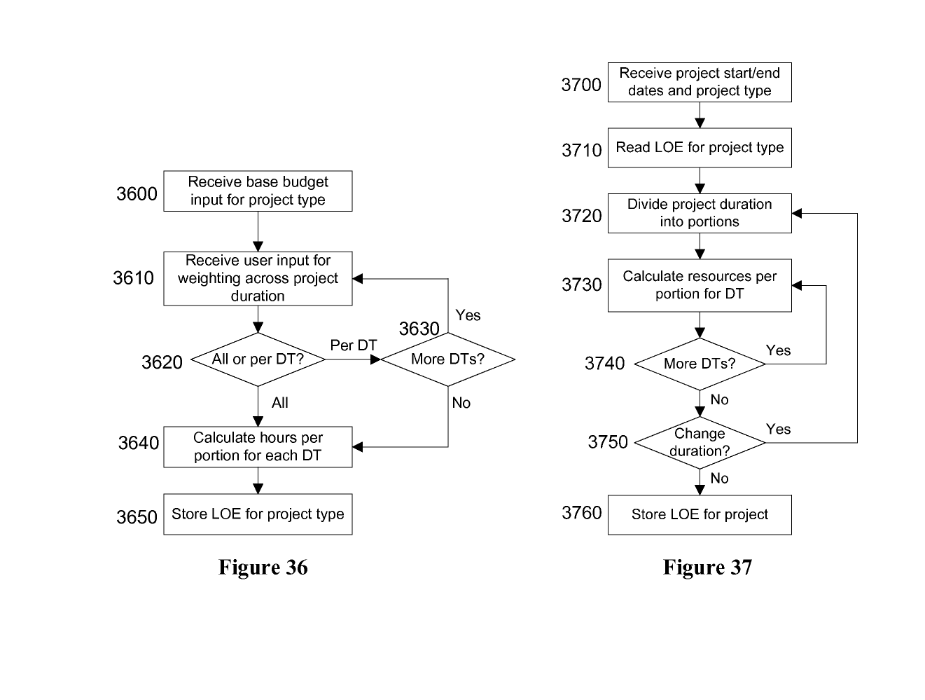

FIG. 36 is an exemplary computerized method or procedure for determining a base budget for a particular type of project, according to one or more embodiments of the present disclosure. Although the exemplary method is illustrated in FIG. 36 by blocks in the particular order shown in FIG. 36, this order is merely exemplary, and the functions corresponding to the blocks may be performed in different orders and can be combined and/or divided into blocks having different functionality than shown in FIG. 36. The exemplary method or procedure proceeds to block 3600, where a base budget input is received for a particular project type. This information may be received in response to user inputs in the context of one or more screen displays described above, e.g., screen display 2600 shown in FIG. 26. For example, the user may enter hours needed for each of the following discipline-titles (DTs) needed for the particular project type: Project Manager (30 hours); Account Manager (15 hours); Designer (40 hours); Writer (25 hours); User Experience Designer (4 hours); and Developer (24 hours). The method proceeds to block 3610, where a user input is received for weighting of the budgeted hours across the project duration. For example, the user input may be provided using graphic equalizer control 2640 shown in FIG. 26 and described above. For example, the user may provide weighting input of 0, 10, 0, 10, 0, 0, 30, 30, 10, and 10 percent, respectively for each 10% portion of the project duration.

In step 3620, it is determined whether the duration weighting input is for a particular single DT or for all DTs. This may be determined, for example, in response to or based on a user input. If for all DTs, the method proceeds to block 3640 where hours per portion is calculated for each of the DTs, e.g., by multiplying the total DT hours by the duration weighting. The method then proceeds to block 3650 where the entered LOE is stored or saved for the particular project type. This may be performed, for example, in response to or based on a user input, e.g., by clicking a “save” button. If the information received in 3610 is for a single DT, the method proceeds to block 3630 where it is determined whether duration weighting input is needed and/or available for other DTs. This may be determined, for example, in response to or based on a user input (e.g., actuation of a save control). If so, the method proceeds to repeat blocks 3610-3630 until it is determined that all duration weighting input has been received, and after which further calculations and storage takes place in blocks 3640 and 3650, respectively. Note, however, that the calculations in block 3640 and store/save operation in block 3650 may take place incrementally, e.g., after receipt of duration weighting information for each DT.

FIG. 37 is an exemplary computerized method or procedure for assigning and/or modifying assignment of resources for the duration of a project, according to one or more embodiments of the present disclosure. Although the exemplary method is illustrated in FIG. 37 by blocks in the particular order shown in FIG. 37, this order is merely exemplary, and the functions corresponding to the blocks may be performed in different orders and can be combined and/or divided into blocks having different functionality than shown in FIG. 37. The method proceeds to block 3700, where information comprising project type, project start date, and project end date is received. This information may be received in response to user inputs, e.g., inputs or selections made in fields 370, 374, and 376, respectively, of project creation display 360 shown in FIG. 3b. In block 3710, the base LOE for the selected project type is read from a storage location, e.g., a database stored in memory. This can be performed automatically in response to entry of project type or upon further user input. In block 3720, the project duration is calculated based on the difference between start date and end date, and the project duration is divided into portions, e.g., ten equal portions of 10%. In some exemplary embodiments, the portions are rounded to the nearest whole day such that the resulting sum of the portions will be less than or equal to the calculated duration. In the event that the sum is less than the duration (e.g., leftover days), the remaining days can be allocated to certain ones of the portions in many different ways known to persons of ordinary skill. For example, one day may be allocated to each portion chronologically, reverse chronologically, with skipped portions, etc.

In block 3730, the resources per project portion is calculated for a particular DT needed in the project. This DT may be selected from the list of DTs comprising the project LOE (e.g., field 385 shown in FIG. 3b), and the resources per portion may be calculated based on the total resources needed for that DT over the project duration (e.g., also shown in field 385) and the percentage of the total per project portion (e.g., as shown in graphic equalizer control 390 of FIG. 3b). In various embodiments, the resources per portion can be calculated as a number of hours, with rounding to any whole or fractional hours as needed or as appropriate. The method proceeds to block 3740 where it is determined whether the project type comprises additional DTs. If so, blocks 3730 and 3740 are repeated until no more DTs remain. Although not shown in FIG. 37, the calculated results may be saved incrementally (e.g., after each DT) and/or after completion of all DTs. The method proceeds to block 3750 where it is determined whether the project duration has been changed, e.g., by receiving additional user input in fields 374 and 376 of FIG. 3b. If so, then the method repeats blocks 3720-3740 to calculate updated per portion allocation for each DT involved in the project. After completion, the method proceeds to block 3760 where the project LOE is stored or saved. This may be performed, for example, in response to or based on a user input, e.g., by clicking save control 395 shown in FIG. 3b.

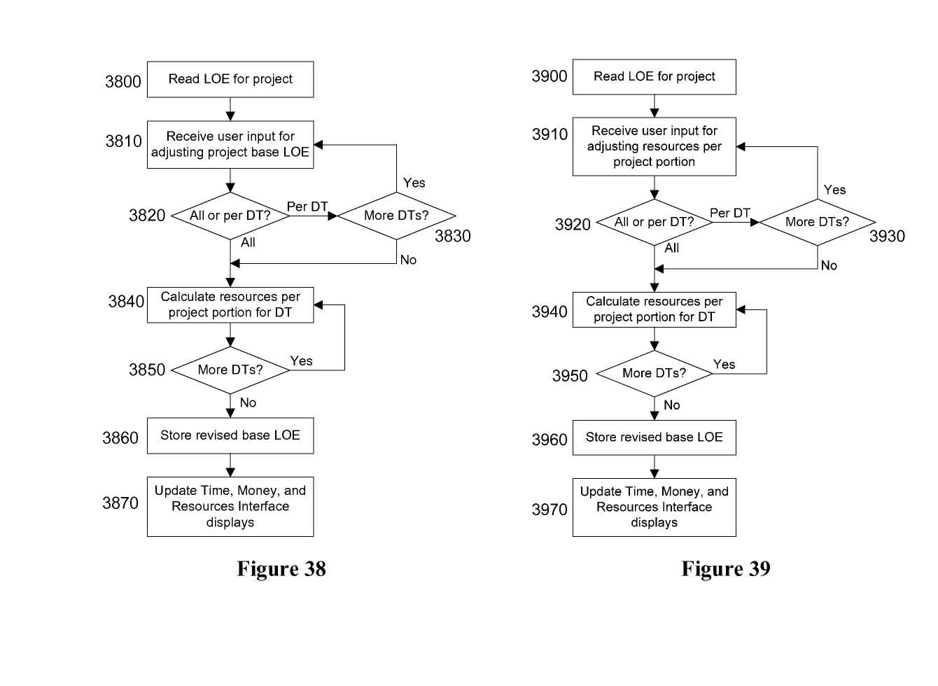

FIG. 38 is an exemplary computerized method for updating one or more screen displays based on input related to the base LOE for one or more disciplines involved in a project, according to one or more embodiments of the present disclosure. Although the exemplary method is illustrated in FIG. 38 by blocks in the particular order shown in FIG. 38, this order is merely exemplary, and the functions corresponding to the blocks may be performed in different orders and can be combined and/or divided into blocks having different functionality than shown in FIG. 38. The method proceeds to block 3800, where the base LOE for a particular project is read from a storage location, e.g., a database stored in memory. This can be performed automatically in response to user selection of a particular project, e.g., selection of icon 310 and PM Admin 330 option shown in display 300 of FIG. 3a, followed by selection of client and project in the PM Admin form of display 360 discussed above with reference to FIG. 3b. The base project LOE may have been previously created and stored, for example, using the exemplary procedures shown in FIG. 37.

The method proceeds to block 3810, where indication of changes to the base project LOE is received. This information may be received in response to user actuation of slider control 387 shown in display 360 of FIG. 3b. For example, the indication may be received in response to a user changing slider control 387 from a setting of 100% to a setting of 200%. In block 3820, it is determined whether the change is for a particular DT or for all DTs. This may be determined, for example, in response to or based on a user input, e.g., the state of All control 386 in display 360. If for all DTs, the method proceeds to block 3840; otherwise blocks 3810-3830 are repeated until no more DTs remain, which may be determined based on a user input (e.g., user actuation of a save control).

In blocks 3840-3850, the resources per project portion are calculated for all DTs involved in a project in a manner similar as described above with respect to blocks 3730-3740 of FIG. 37. After completion, the method proceeds to block 3860 where the project LOE is stored or saved. This may be performed, for example, in response to or based on a user input, e.g., by clicking save control 395 shown in FIG. 3b. In block 3870, various information displays are update according to the revised project information. In some embodiments, time display 100 shown in FIG. 1 may be updated graphically to reflect the revised resource requirements for the particular project. For example, changing the LOE will change the number of hours required by certain DTs. Multi-color bar 136 illustrates resource conditions (e.g., resource requirements as a percentage of resource availability) over a particular period of an active project. The revised resource requirement will cause a change in resource conditions, which may result in color changes to one or more segments of multi-color bar 136.

The revised resource requirement will also cause a change in the dollar value of the project. This may cause an update in forecast totals 150 and 153 shown in display 100. Block 3870 may also include updating one of more displays of the money interface, such as displays 600 and 700 shown in FIGS. 6 and 7, respectively. For example, if the user has selected icon 710 and the sort option from primary menu 740, the revised resource requirements may cause the application to update the forecast totals displayed according to the choice of options from secondary menu 745, tertiary menu 750, and/or quaternary menu 755. Such updates may include both the height and color of one or more vertical revenue bars (e.g., 620 and 625 in FIG. 6) as well as the revenue scale (e.g., 615a and 615b). Block 3870 may also include updating one of more displays of the people (or resources) interface, such as display 800 shown in FIG. 8. For example, vertical bars represents resource utilization percentage during a particular day of the selected period.

Revised resource requirements can result in changes to resource utilization percentage. Since resource utilization is expressed by the colors of the vertical bars, revised resource requirements for an active project may cause updates to the colors of one or more vertical bars (e.g., 820 and 825). Alternately, such revisions may cause the relative amounts of the respective colors to change for one or more vertical bars, or lead to changes in the resource utilization scales (e.g., 815a, 815b). However, the graphical updates described above are merely exemplary and the skilled person will recognize other features and information in these and other displays may be updated in response to revised resource utilization. Moreover, the graphical updates to each of the interfaces—time, money, and people (resources)—can occur automatically upon display of that particular interface, such as in response to selection of a user interface element (e.g., one of icons 103, 106, and 109 in display 100 of FIG. 1) corresponding to that particular interface.

FIG. 39 is an exemplary computerized method for updating one or more screen displays based on input related to distribution of project resources across the duration of a project, according to one or more embodiments of the present disclosure. Although the exemplary method is illustrated in FIG. 39 by blocks in the particular order shown in FIG. 39, this order is merely exemplary, and the functions corresponding to the blocks may be performed in different orders and can be combined and/or divided into blocks having different functionality than shown in FIG. 39. The method proceeds to block 3900, where the base LOE for a particular project is read from a storage location, e.g., a database stored in memory. In some embodiments, the operations in this block are substantially similar to those described above with respect to block 3800 of FIG. 38.

The method proceeds to block 3910, where indication of changes to resource allocation per portion of project duration is received. This information may be received in response to user actuation of one or more controls of graphic equalizer control 395 shown in display 360 of FIG. 3b, and described in more detail above with respect to control 2640 shown in display 2600 of FIG. 26. Each portion of the duration is associated with a particular slider bar (e.g., slider bar 2642) that may be repositioned by, e.g., click, hold, and drag operation, thereby changing the portion of total hours assigned to the corresponding portion of the project duration. Any 10% portion of the project duration can contain as little as 0% and as much as 100% of the total hours assigned.

In block 3920, it is determined whether the change is for a particular DT or for all DTs. This may be determined, for example, in response to or based on a user input, e.g., the state of All control 386 in display 360. If for all DTs, the method proceeds to block 3940; otherwise blocks 3910-3930 are repeated until no more DTs remain, which may be determined based on a user input (e.g., user actuation of a save control). In blocks 3940-3950, the resources per project portion are calculated for all DTs involved in a project in a manner similar as described above with respect to blocks 3730-3740 of FIG. 37. After completion, the method proceeds to block 3960 where the project LOE is stored or saved. This may be performed, for example, in response to or based on a user input, e.g., by clicking save control 395 shown in FIG. 3b. In block 3970, one or more information displays are update according to the revised project information. In some embodiments, these updates may be performed in manner substantially similar as described for block 3870 above.

FIG. 42 is an exemplary computerized method for updating one or more screen displays based on input related to changes in the duration of a project, according to one or more embodiments of the present disclosure. Although the exemplary method is illustrated in FIG. 42 by blocks in the particular order shown in FIG. 42, this order is merely exemplary, and the functions corresponding to the blocks may be performed in different orders and can be combined and/or divided into blocks having different functionality than shown in FIG. 42. The method proceeds to block 4200, where the base LOE for a particular project is read from a storage location, e.g., a database stored in memory. In some embodiments, the operations in this block are substantially similar to those described above with respect to block 4200 of FIG. 42.

The method proceeds to block 4210, where indication of changes to the project duration is received. For example, indication to changes made to at least one of the project start date and the project end date can be received. This information can be received in response to user manipulation of graphical bar spanning at least a portion of the duration of the project, such as multi-color bar 136 shown in display 100 of FIG. 1. Such manipulations may comprise selecting (e.g., click and hold) the beginning or end of a colored bar (e.g., 140) and moving (e.g., dragging) the selected portion in a desired direction (e.g., left or right), thereby increasing or decreasing the duration of a particular project. Such manipulations may also comprise selecting (e.g., click and hold) the middle of a colored bar (e.g., 140) and moving (e.g., dragging) the selected bar in a desired direction (e.g., left or right), thereby changing the execution period of the particular project.

In response to the indication received in block 4210, the resources per project portion are calculated in blocks 4220-4230 for all DTs involved in a project in a manner similar as described above with respect to blocks 3730-3740 of FIG. 37. After completion, the method proceeds to block 4240 where the project LOE is stored or saved. This can be performed automatically or in response to or based on a user input, e.g., by actuation of a save control. In block 4250, one or more information displays are update according to the revised project information. In some embodiments, these updates may be performed in manner substantially similar as described for block 3870 above.

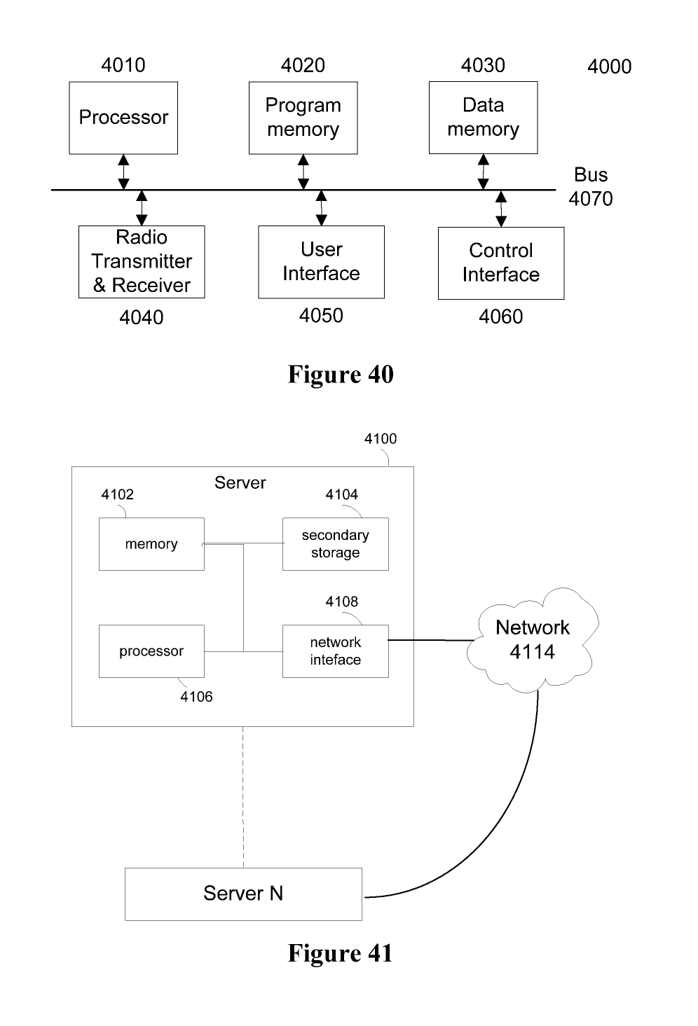

FIG. 40 is a block diagram of exemplary user interface device or apparatus utilizing certain embodiments of the present disclosure, including execution of the application program that may cause display of one or more of the exemplary screen displays shown in FIGS. 1 through 35 or perform the procedures comprising the exemplary methods shown in FIGS. 36 through 39. Device 4000 comprises processor 4010 that is operably connected to program memory 4020 and data memory 4030 via bus 4070 that may comprise parallel address and data buses, serial ports, or other methods and/or structures known to those of ordinary skill in the art. Program memory 4020 comprises software code executed by processor 4010 that enables device 4000 to communicate using one or more wired or wireless communication protocols, including one or more wireless communication protocols standardized by 3GPP, 3GPP2, or IEEE, such as those commonly known as LTE, UMTS, HSPA, GSM, GPRS, EDGE, 1xRTT, CDMA2000, 802.11, WiFi, HDMI, USB, Firewire, etc., or any other protocols utilized in conjunction with radio transceiver 4040, user interface 4050, and/or host interface 4060. Program memory 4020 further comprises software code executed by processor 4010 to control the functions of device 4000, including configuring and controlling various components such as radio transceiver 4040, user interface 4050, and/or host interface 4060. Program memory 4020 may also comprise the application program that may cause display of one or more of the exemplary screen displays shown in FIGS. 1 through 35 and/or perform the procedures comprising the exemplary methods shown in FIGS. 36 through 39. Such software code may be specified or written using any known or future developed programming language, such as e.g. Java, C++, C, Objective C, HTML, XHTML, and Assembler, as long as the desired functionality, e.g., as defined by the implemented method steps, is preserved.

Data memory 4030 may comprise memory area for processor 4010 to store variables used in protocols, configuration, control, and other functions of device 4000, including the display of one or more of the exemplary screen displays shown in FIGS. 1 through 35 and the database described with reference to various ones of these figures. As such, program memory 4020 and data memory 4030 may comprise non-volatile memory (e.g., flash memory), volatile memory (e.g., static or dynamic RAM), or a combination thereof. Furthermore, data memory 4030 may comprise a memory slot by which removable memory cards in one or more formats (e.g., SD Card, Memory Stick, Compact Flash) may be inserted and removed. Persons of ordinary skill in the art will recognize that processor 4010 may comprise multiple individual processors (e.g., multi-core processors), each of which implements a portion of the functionality described above. In such case, multiple individual processors may be commonly connected to program memory 4020 and data memory 4030 or individually connected to multiple individual program memories and or data memories. More generally, persons of ordinary skill in the art will recognize that various protocols and other functions of device 4000 may be implemented in many different combinations of hardware and software including, but not limited to, application processors, signal processors, general-purpose processors, multi-core processors, ASICs, fixed digital circuitry, programmable digital circuitry, analog baseband circuitry, radio-frequency circuitry, software, firmware, and middleware.

Radio transceiver 4040 may comprise radio-frequency transmitter and/or receiver functionality that enables device 4000 to communicate with other equipment supporting like wireless communication standards. In an exemplary embodiment, radio transceiver 4040 includes an LTE transmitter and receiver that enable device 4000 to communicate with various Long Term Evolution (LTE) networks (also known as “4G”) according to standards promulgated by 3GPP. In some embodiments, radio transceiver 4040 includes circuitry, firmware, etc. necessary for device 4000 to communicate with various UMTS and/or GSM/EDGE networks, also according to 3GPP standards. In some embodiments, radio transceiver 4040 includes circuitry, firmware, etc. necessary for device 4000 to communicate with various CDMA2000 networks, according to 3GPP2 standards. In some embodiments, radio transceiver 4040 is capable of communicating using radio technologies that operate in unlicensed frequency bands, such as IEEE 802.11 WiFi that operates using frequencies in the regions of 2.4 and/or 5.6 GHz. In some embodiments, radio transceiver 4040 may comprise a transceiver that is capable of wired communication, such as by using IEEE 802.3 Ethernet technology. The functionality particular to each of these embodiments may be coupled with or controlled by other circuitry in device 4000, such as processor 4010 executing protocol program code stored in program memory 4020.

User interface 4050 may take various forms depending on the particular embodiment of device 4000. In some embodiments, device 4000 is a mobile phone, in which case user interface 4050 may comprise a microphone, a loudspeaker, slidable buttons, depressable buttons, a display, a touchscreen display, a mechanical or virtual keypad, a mechanical or virtual keyboard, and/or any other user-interface features commonly found on mobile phones. In such mobile phone embodiments, the particular features comprising the device may depend on whether the device is a smartphone, feature phone, or other type of mobile phone. In other embodiments, device 4000 is a tablet computing device (such as an iPad® sold by Apple, Inc.) comprising a touchscreen display that is much larger than touchscreen displays found on mobile phones. In such tablet embodiments, one or more of the mechanical features of user interface 4050 may be replaced by comparable or functionally equivalent virtual user interface features (e.g., virtual keypad, virtual buttons, etc.) implemented using the touchscreen display of device 4000, as familiar to persons of ordinary skill in the art. In other embodiments, device 4000 may be a digital computing device, such as a laptop computer, desktop computer, workstation, etc. that comprises a mechanical keyboard that may be integrated, detached, or detachable depending on the particular embodiment. Such a digital computing device may also comprise a touch screen display. All embodiments of device 4000 having a touch screen display are capable of receiving the user inputs for selection and manipulation of content, as described above with reference to FIGS. 1 through 39.

In some embodiments, device 4000 may comprise an orientation sensor, which can be used to sense when the user has changed the physical orientation of the device 4000's touch screen display. An indication signal from the orientation sensor may be available to any application program executing on device 4000, such that an application program may change the orientation of a screen display (e.g., from portrait to landscape) automatically when the indication signal shows a 90-degree change in physical orientation of the device. In this manner, the application program can maintain the screen display in a manner that is readable by the user, regardless of the physical orientation of the device.

Host interface 4060 of device 4000 also may take various forms depending on the particular embodiment of device 4000. In embodiments where device 4000 is a mobile phone, host interface 4060 may comprise a USB interface, an HDMI interface, or the like. In some embodiments, device 4000 may comprise more functionality than is shown in FIG. 40. In some embodiments, device 4000 may also comprise functionality such as a video and/or still-image camera, microphone, media player, etc., any of which may be used to capture and/or process media items used in conjunction with collaboration threads, as described above with reference to FIGS. 1 through 35. Moreover, radio transceiver 4040 may include circuitry necessary to communicate using additional radio-frequency communication standards including Bluetooth, GPS, and/or others. Persons of ordinary skill in the art will recognize the above list of features and radio-frequency communication standards is merely exemplary and not limiting to the scope of the present disclosure. Accordingly, processor 4010 may execute software code stored in program memory 4020 to control such additional functionality.

FIG. 41 is a block diagram of an exemplary server that may be utilized in conjunction with certain embodiments of the present disclosure, including communication with a user interface device (e.g., device 4000 shown in FIG. 40) that displays one or more of exemplary screen displays shown in FIGS. 1 through 35 and/or perform the procedures comprising the exemplary methods shown in FIGS. 36 through 39. Server 4100 typically includes a memory 4102, a secondary storage 4104, a processor 106 and a network interface 4108. Memory 4102 may include RAM or similar types of memory, and it may store one or more applications (e.g., database applications, communication applications, security applications, etc.) for execution by processor 4106. Secondary storage 4104 may include a hard disk drive, floppy disk drive, CD-ROM drive, or other types of non-volatile data storage. Processor 4106 executes the application(s), which is stored in memory 4102 or secondary storage 4104, or received from the Internet or other network 4114.

Server 4100 may store a database structure in secondary storage 4104, for example, for storing and maintaining information need or used by the application(s). Also, processor 4106 may execute one or more software applications in order to provide the functions described in this specification, specifically in the methods and screen displays described above, and the processing may be implemented in software, such as software modules, for execution by computers or other machines. The processing may provide and support web pages and other GUIs. The GUIs may be formatted, for example, as web pages in HyperText Markup Language (HTML), Extensible Markup Language (XML) or in any other suitable form for presentation on an exemplary user interface device.

Network interface 4108 may comprise transmitters, receivers, and other circuitry that enables server 4100 to communicate with other equipment in a packet and/or circuit-switched network for purposes of normal operation, as well as for administration and maintenance of server 4100 or other network equipment operably connected thereto. In some embodiments, network interface 4108 may comprise one or more of asynchronous transfer mode (ATM), Internet Protocol (IP)-over-Ethernet, SDH over optical fiber, T1/E1/PDH over a copper wire, microwave radio, or other wired or wireless transmission technologies known to those of ordinary skill in the art.

Although server 4100 is depicted with various components, one skilled in the art will appreciate that the servers can contain additional or different components. In addition, although aspects of an implementation consistent with the above are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or ROM. The computer-readable media may include instructions for controlling a computer system, such as server 4100, to perform a particular method.

As described herein, a device or apparatus may be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. A device or apparatus may be regarded as a device or apparatus, or as an assembly of multiple devices and/or apparatuses, whether functionally in cooperation with or independently of each other. Moreover, devices and apparatuses may be implemented in a distributed fashion throughout a system, so long as the functionality of the device or apparatus is preserved. Such and similar principles are considered as known to a skilled person.

More generally, even though the present disclosure and exemplary embodiments are described above with reference to the examples according to the accompanying drawings, it is to be understood that they are not restricted thereto. Rather, it is apparent to those skilled in the art that the disclosed embodiments can be modified in many ways without departing from the scope of the disclosure herein. Moreover, the terms and descriptions used herein are set forth by way of illustration only and are not meant as limitations. Those skilled in the art will recognize that many variations are possible within the spirit and scope of the disclosure as defined in the following claims, and their equivalents, in which all terms are to be understood in their broadest possible sense unless otherwise indicated.

What is claimed is:

1. A user interface device capable of interactive selection and display of project management information, comprising:
a display;
a processor; and
at least one memory including program code that, when executed by the processor, causes the user interface device to:
display first graphical information relating to a plurality of resources and to a project duration;
receive a first signal indicating user modification of at least a portion of the displayed graphical information;
calculate a revised allocation over the project duration for at least one of the plurality of resources; and
display second graphical information based on the calculated revised allocation of resources.

2. The user interface device of claim 1, wherein the first graphical information comprises the total number of hours allocated over the project duration for each of the resources.

3. The user interface device of claim 1, wherein the first graphical information comprises portions of the total number of hours for one or more resources that are allocated in a plurality of portions of the project duration.

4. The user interface device of claim 3, wherein the plurality of portions comprise equal portions.

5. The user interface device of claim 3, wherein the first signal indicates user modification of at least one of the portions of the total number of hours that are allocated in the plurality of portions of the project duration.

6. The user interface device of claim 5, wherein:
the display is a touch screen display; and
the first signal is generated in response to actuation of a graphic equalizer control rendered on the touch screen display by the user interface device.

7. The user interface device of claim 2, wherein the first signal indicates user modification of the total number of hours allocated over the project duration for at least a portion of the resources.

8. The user interface device of claim 7, wherein:
the display is a touch screen display; and
the first signal is generated in response to actuation of a slider control rendered on the touch screen display by the user interface device.

9. The user interface device of claim 1, wherein the at least one memory further comprises program code that, when executed by the processor, causes the user interface device to receive a second signal indicating that the user modification shall apply proportionally to all resources assigned to the project.

10. The user interface device of claim 1, wherein the first signal indicates user modification of at least one of the project start date and the project end date.

11. The user interface device of claim 10, wherein:
the display is a touch screen display;
the first graphical information comprises a multi-segment bar indicating resource allocation over at least a portion of the project duration; and
the first signal is generated in response to at least one of a change in the position of the multi-segment bar and a change in length of the multi-segment bar.

12. The user interface device of claim 1, wherein the second graphical information comprises utilization percentage of at least one resource during at least one day of the project duration.

13. The user interface device of claim 1, wherein the second graphical information comprises resource allocation as a percentage of project requirement during at least one day of the project duration.

14. The user interface device of claim 1, wherein the second graphical information comprises a monetary forecast.

15. The user interface device of claim 1, wherein the at least one memory further comprises program code that, when executed by the processor, causes the user interface device to receive a third signal and to display the second graphical information in response to receiving the third signal.

16. The user interface device of claim 1, wherein the program code that causes the user interface device to calculate a revised allocation further comprises program code that, when executed by the processor, causes the user interface device to calculated a revised number of hours required during each portion of the project duration for at least one of: one or more individual resources and one or more groups of resources.

17. The user interface device of claim 1, wherein:
the at least one memory further comprises program code that, when executed by the processor, causes the user interface device to read a project template from the at least one memory; and
the first graphical information is displayed based on the read project template.

18. The user interface device of claim 1, wherein at least one of the first and second graphical information comprises one or more color-coded elements.

19. A non-transitory, computer-readable medium comprising a set of instructions that, when executed by an apparatus comprising at least one processor and capable of interactive selection and display of project management information, cause the apparatus to:
display first graphical information relating to a plurality of resources and to a project duration;
receive a first signal indicating user modification of at least a portion of the displayed graphical information;
calculate a revised allocation over the project duration for at least one of the plurality of resources; and
display second graphical information based on the calculated revised allocation of resources.

20. The non-transitory, computer-readable medium of claim 19, wherein the first graphical information comprises portions of the total number of hours for one or more resources that are allocated in a plurality of portions of the project duration.

21. The non-transitory, computer-readable medium of claim 20, wherein the first signal indicates user modification of at least one of the portions of the total number of hours that are allocated in the plurality of portions of the project duration.

22. The non-transitory, computer-readable medium of claim 19, wherein the first signal indicates user modification of the total number of hours allocated over the project duration for at least a portion of the resources.

23. The non-transitory, computer-readable medium of claim 19, wherein the at least one memory further comprises program code that, when executed by the processor, causes the user interface device to receive a second signal indicating that the user modification shall apply proportionally to all resources assigned to the project.

24. The non-transitory, computer-readable medium of claim 19, wherein the first signal indicates user modification of at least one of the project start date and the project end date.

25. The non-transitory, computer-readable medium of claim 19, wherein the second graphical information comprises utilization percentage of at least one resource during at least one day of the project duration.

26. The non-transitory, computer-readable medium of claim 19, wherein the second graphical information comprises resource allocation as a percentage of project requirement during at least one day of the project duration.

27. The non-transitory, computer-readable medium of claim 19, wherein the second graphical information comprises a monetary forecast.

28. The non-transitory, computer-readable medium of claim 19, wherein the at least one memory further comprises program code that, when executed by the processor, causes the user interface device to receive a third signal and to display the second graphical information in response to receiving the third signal.

29. A method for interactive selection and display of project management information, comprising:
displaying, on a display screen, first graphical information relating to a plurality of resources and to a project duration;
receiving a first signal indicating user modification of at least a portion of the displayed graphical information;
calculating a revised allocation over the project duration for at least one of the plurality of resources; and
displaying, on the display screen, second graphical information based on the calculated revised allocation of resources.

30. The method of claim 29, wherein the first graphical information comprises portions of the total number of hours for one or more resources that are allocated in a plurality of portions of the project duration.

31. The method of claim 30, wherein the first signal indicates user modification of at least one of the portions of the total number of hours that are allocated in the plurality of portions of the project duration.

32. The method of claim 29, wherein the first signal indicates user modification of the total number of hours allocated over the project duration for at least a portion of the resources.

33. The method of claim 29, further comprising receiving a second signal indicating that the user modification shall apply proportionally to all resources assigned to the project.

34. The method of claim 29, wherein the first signal indicates user modification of at least one of the project start date and the project end date.

35. The method of claim 29, wherein the second graphical information comprises utilization percentage of at least one resource during at least one day of the project duration.

36. The method of claim 29, wherein the second graphical information comprises resource allocation as a percentage of project requirement during at least one day of the project duration.

37. The method of claim 29, wherein the second graphical information comprises a monetary forecast.

38. The method of claim 29, further comprising: receiving a third signal; and displaying the second graphical information in response to receiving the third signal.
